(19) United States
(12) Patent Application Publication
(10) Pub. No.: US 2014/0081814 A1
(43) Pub. Date: Mar. 20, 2014

(54) ACCOUNTING JOURNALIZATION FILE DATA STANDARDIZATION SYSTEM

(71) Applicant: Kabushiki Kaisha YK Planning, Yamaguchi (JP)

(72) Inventors: Yasufumi Yukumoto, Yamaguchi (JP); Tatsunori Okamoto, Yamaguchi (JP); Akira Inamine, Yamaguchi (JP)

(73) Assignee: Kabushiki Kaisha YK Planning, Yamaguchi (JP)

(21) Appl. No.: 14/086,510

(22) Filed: Nov. 21, 2013

Related U.S. Application Data
(63) Continuation of application No. PCT/JP2012/064230, filed on May 31, 2012.

(30) Foreign Application Priority Data
Jun. 2, 2011 (JP) 2011-124613

(51) Int. Cl. G06Q 40/00

(52) U.S. Cl. CPC G06Q 40/12
USPC 705/30

(57) ABSTRACT

An accounting journalization file data standardization system performs account processing common to each related party by use of accounting journalization files from a plurality of related parties. In the system, a standard title search unit that searches for a matched title in which a standard title ID stored in a matched title information database is linked to a debit title name and/or a credit title name for which a related-party title search unit was not able to search while using the title names as keys and that links the standard title ID of the matched title to the debit title name and/or the credit title name for which the related-party title search unit was not able to search.

### CROSS-REFERENCE TO RELATED APPLICATIONS

This application is a continuation application of International Patent Application No. PCT/JP2012/064230 filed on May 31, 2012, which claims priority to Japanese Patent Application No. 2011-124613 filed on Jun. 2, 2011 in Japan.

### BACKGROUND OF INVENTION

1. Field of the Invention

The present invention relates to an accounting journalization file data standardization system that standardizes accounting journalization file data in order to perform account processing common to all related parties by use of accounting journalization files from multiple related parties, and relates to an audit system that performs an audit by use of the standardization system, and relates to programs for those systems.

2. Background Art

In recent years, the change from journalizing processing in which journal entries are recorded in a ledger in detail every day to journalizing processing in which pieces of data are input by installing accounting software on personal computers has been made in daily account/tax processing jobs in business enterprises, organizations, and sole proprietors.

Accounting software has been sold from various software houses, and software provided via the Internet has also appeared.

In this situation, there is a case in which pieces of software that differ from each other are used between a head office and branch offices of a business enterprise, or different pieces of software are used among business enterprises and sole proprietors that are parties involved with a certified tax accountant office or an accounting office, and, as a result of data compilation by use of such different pieces of software, the fact that specifications of an accounting journalization file become different has frequently occurred.

Therefore, a conventional problem resides in the fact that common account processing, such as auditing service, by use of accounting journalization files cannot be performed in a business enterprise while using a single piece of software, and the account processing needs to be individually performed according to each accounting journalization file, and becomes complex. Another conventional problem resides in the fact that each command and each procedure of different pieces of software need to be learned and executed above all, and, in the first place, different software has different in function, and therefore, for example, a user needs manually retype correct data at incorrectly input places and it is not efficient as it requires complicated and enormous effort.

Additionally, disadvantageously, many pieces of accounting software allow a user to independently add debit title names and credit title names or to independently make corrections, and the user customizes those title names according to enterprise contents, and this further makes account processing performed by use of accounting journalization files complicated, in addition to differences in specifications among software houses.

Therefore, so far, various techniques have been developed in order to solve the complexity of journalizing processing or the complexity of tax/account processing.

For example, Patent Literature 1, which is entitled “ENTRY SYSTEM, ABSTRACT DICTIONARY EDITING SCREEN, METHOD FOR REGISTERING ABSTRACT, METHOD FOR EDITING ABSTRACT DICTIONARY, PROGRAM, AND STORAGE MEDIUM,” discloses an account processing system that enables small-scale corporations and sole proprietors without knowledge about accounting and tax to easily input accounting data.

This entry system includes a data input screen provided with a plurality of data input/display rows, an abstract dictionary that stores title information, such as abstracts, account titles and taxation categories that are correlated to each other, an abstract character string designating means that designates a desired abstract character string among abstract character strings displayed on the data input/display column into which data have been input, an abstract registration instructing means that issues a command to register the abstract character string designated by the abstract character string designating means in an abstract dictionary, and an abstract dictionary record registering means that, based on the abstract registration command issued by the abstract registration instructing means, generates an abstract dictionary record including the abstract character string designated by the abstract character string designating means and title information correlated to the abstract character string and then registers it in the abstract dictionary.

In the thus arranged entry system, an abstract character string that a user considers as necessary can be registered in the abstract dictionary by executing the registration command when automatic journalization is performed by inputting the abstract on the entry screen, and therefore, it is possible to save the time for opening an abstract registration screen each time by individually inputting an abstract character string to the abstract dictionary.

Additionally, Patent Literature 2, which is entitled “DEVICE, METHOD AND PROGRAM FOR CREATING HIERARCHICAL DOCUMENT INFORMATION,” discloses a technique in which an element is obtained from a correspondence table while an account title identifier corresponding to an account title included in financial information is used as a key, in which another account title is obtained from a dictionary while using the element obtained as a key, in which a comparison is made between the account title included in the financial information and the account title obtained, in which the account title included in the financial information is added to the dictionary if its comparison result shows that they do not match with each other, and in which hierarchical document information is created based on the financial information and the dictionary.

According to this technique, the account title included in the financial information is added to the dictionary so as to create hierarchical document information when the account title included in the financial information does not match with the account title obtained from the dictionary as a result of a comparison therebetween, and therefore, an account title cannot be selected without user's recognition, and user-friendliness can be improved.

Additionally, Patent Literature 3 (PTL 3), which is entitled “ACCOUNTING INFORMATION COLLECTION AND ANALYSIS SYSTEM, AND METHOD AND PROGRAM THEREFOR,” discloses a technique for a system and the like for performing financial processing relative to accounting information that is capable of calculating a management index at any time and capable of assisting the analysis of financial statements by collecting and analyzing transaction data.

The technique disclosed by this literature is to assist the analysis of business conditions by converting transaction data input by a plurality of business systems that is original transaction data concerning account titles of standardized financial statements into a data format of a unified structured language (data format of, for example, XBRL (eXtensible Business Report Language)) and by storing the resultant data in a database. Additionally, in this technique, the transaction data input from the external business systems are converted into accounting titles of a standardized financial statements structure rule and structured languages unified by use of a data conversion structure rule including the same titles, and the resultant data are stored as financial information data, and, as a result, it becomes possible to reuse data without depending on an OS (operating system) or a platform.

The use of this financial statements structure rule makes it possible to link the financial statements created by the external business systems and the stored financial data to each other while using the element name of the account title as a key at a financial statements linkage part, and, as a result, it becomes possible, for example, to collect the original transaction data of each account title of financial statements, and therefore, it becomes possible to perform a more detailed business analysis of financial statements that has conventionally been impossible.

Patent Literature 4, which is entitled “JOURNALIZING DATA PREPARATION METHOD AND JOURNALIZING DATA PREPARATION PROGRAM,” discloses a technique for obtaining journalizing data for preparing a desired journal slip without depending on the kind and form of input data. This technique includes a journalizing processing part in which a record relative to journalizing data is taken out from the DB for each purpose while freely using a journalizing control master and a journalizing master, thereafter a journalizing control pattern matched with the record is taken out from the journalizing control master, thereafter a journalizing basic pattern is taken out from the journalizing master with the value of an item to be a journalizing condition key in the journalizing control pattern as a retrieval key, and thereafter the journalizing data are generated based on the item to actually appear in the journalizing data included in the journalizing basic pattern.

According to this technique, it is possible to obtain journalizing data for preparing a desired journal slip without depending on the kind and form of input data.

### CITATION LIST

Patent Literature 1: Japanese Published Unexamined Patent Application No. 2003-346072
Patent Literature 2: Japanese Published Unexamined Patent Application No. 2005-267195
Patent Literature 3: Japanese Published Unexamined Patent Application No. 2008-165641
Patent Literature 4: Japanese Published Unexamined Patent Application No. 2006-99516

However, these techniques disclosed by Patent Literatures 1 to 4 have a conventional problem in the fact that tax/account processing cannot be performed compatibly among different pieces of accounting journalization files created after performing journalizing processing although effort and time for performing daily journalizing processing can be efficiently expended. As described above, a conventional problem resides in the fact that there exist a plurality of pieces of software for creating an accounting journalization file, and these pieces of software have specifications differing from each other, and are customized by users, and it is impossible to meet a desire to achieve compatible process this.

Additionally, the technique disclosed by Patent Literature 2 has a conventional problem in the fact that hierarchical document information common to each of the accounting journalization files different from each other is not necessarily created securely, and, after all, this technique remains only in the convenience of, for example, a case in which customization is performed by persons using each individual accounting journalization file although hierarchical document information is created by automatic addition to a dictionary with respect to different account titles depending on accounting journalization files, and therefore, users do not need to select an account title from among those account titles.

Additionally, according to the technique disclosed by Patent Literature 3, a data format of a structured language unifying transaction data that are input from a plurality of business systems is used, and therefore, the data format common to the plurality of accounting journalization files is employed, and, as described in this literature, it becomes possible to at any time calculate a management index that can be subjected to an arithmetic operation according to various arithmetic expressions.

In this technique, transaction data, such as amount of sales and sales days, that are input from a business system, such as a sales management system, are converted into an instance document that is a file of a data format of a structured language reusable on a computer at each transaction, and are successively stored in an instance database. When the management index is required to be calculated, an account title that is used for the arithmetic expression of a management index desired to be calculated from instance data is taken out, and an account title of financial statements taxonomy that is normally used is taken out by using the above account title as a key, and thereafter a search is performed for the financial information instance database while using an element name of the account title of the financial statements taxonomy as a key, and a financial index instance and a management index instance are created.

However, in this technique, a pre-shared data format is used whenever daily transaction data are input, or a pre-shared data format is used for conversion of daily transaction data, and, so to speak, shared elements have been taken since an accounting journalization file is created, and effort and time generated after the creation of the accounting journalization file are merely shifted to the creation time of the journalization file. Therefore, a conventional problem resides in the fact that this technique is not realistic, for example, in a case in which the specifications of the accounting journalization files differ from each other, for example, when a plurality of different pieces of software are used among many business enterprises and many sole proprietors involved with a certified tax accountant office or an accounting office although this technique might also be applicable if it is tax/account processing business between a head office and a branch office in the same business enterprise.

One or more embodiments of the present invention has been made in consideration of these conventional circumstances, and the inventors have an object to provide an accounting journalization file data standardization system, an audit system using this standardization system, and programs for these systems capable of providing high accuracy, uniform, and a service having a high additional value level with respect to all related parties (a concept including a head office, branch offices, departments of a business enterprise, offices at which tax/account services are performed, and customers thereof) so that a tax/account processing job can be performed by unifying different pieces of transaction data generated in different branch offices or different departments of a diversifying business enterprise or when a tax/account processing job is performed based on different accounting journalization files of different business enterprises and different sole proprietors who are the expanding related parties.

### SUMMARY OF INVENTION

Various embodiments of the invention for addressing the above issues will be explained individually below. As may be required, the characteristic operational effects of the embodiments will also be described.

In the first embodiments of the present invention, the accounting journalization file data standardization system is an accounting journalization file data standardization system that performs account processing common to each related party by use of accounting journalization files from a plurality of related parties, and the accounting journalization file data standardization system includes:

a file data placement information database that stores a data placement structure relative to data items and data positions of accounting journalization files created by a plurality of specifications differing from each other; a file data placement standardization unit that reads in the related-party accounting journalization file, thereafter reads out a related-party data placement structure corresponding to a specification that has created the related-party accounting journalization file from the file data placement information database, thereafter searches for enumerating data included in the related-party accounting journalization file in accordance with the related-party data placement structure, and generates and outputs a related-party standardization file in which the data item and the data position of the related-party data placement structure are combined with each piece of data included in the enumerating data;

giving a standard title ID regarding a predetermined desired debit title name and/or a credit title name as a standard title name;

a related-party title information database that stores a linkage title in which the standard title ID of the standard title name desirably correlated is linked to the debit title name and/or the credit title name of the data items of the related-party standardization file;

a matched title information database that collects linkage titles in each of which the standard title ID of the standard title name desirably correlated is linked to the debit title name and/or the credit title name of the data items of the related-party standardization files and that stores these linkage titles as matched titles; and

a title matching processing unit that links the standard title ID of the standard title name desirably correlated is linked to the debit title name and/or the credit title name of the data items of the related-party standardization files,

and the title matching processing unit includes:

a related-party title search unit that extracts the debit title name and/or the credit title name of the data items from the related-party standardization files and searches for a linkage title to which the standard title ID stored in the related-party title information database is linked while using these title names as keys; and

a standard title search unit that searches for a matched title in which the standard title ID stored in the matched title information database is linked to the debit title name and/or the credit title name for which the related-party title search unit was not able to search while using these title names as keys and that links the standard title ID of the matched title to the debit title name and/or the credit title name for which the related-party title search unit was not able to search.

With regard to operations of the first embodiments of the present invention, in the accounting journalization file data standardization system arranged as above, a data placement structure relative to data items and data positions of accounting journalization files created by a plurality of specifications differing from each other is stored in a file data placement information database, and therefore, the file data placement standardization unit reads out a related-party data placement structure corresponding to a specification that has created the related-party accounting journalization file when a related-party accounting journalization file is read in, and thereafter searches for enumerating data included in the related-party accounting journalization file, and combines the related-party data placement structure with each piece of data included in the enumerating data. Additionally, with regard to operations of the first embodiments of the present invention, a related-party standardization file in which each piece of data included in the enumerating data of the related-party accounting journalization file has been combined with the related-party data placement structure is generated and output.

In the present invention and/or its one or more embodiments, the accounting journalization file of a related party may be referred to as a related-party accounting journalization file, and the data placement structure of the related-party accounting journalization file is referred to as a related-party data placement structure.

Additionally, with regard to operations of the first embodiments of the present invention, in the accounting journalization file data standardization system arranged as above, the accounting journalization file is generated as a related-party standardization file, and thereafter debit title names and credit title names included in this file are subjected to matching processing.

In more detail, with regard to operations of the first embodiments of the present invention, the related-party title search unit of the title matching processing unit extracts debit title names and/or credit title names of data items included in the related-party standardization file, and a search is made for a linkage title that has already provided with a standard title ID from the related-party title information database while using these as keys.

This processing is completed, and, as a result, a standard title ID is linked through a linkage title to a debit title name and/or a credit title name used in the related-party standardization file.

Although the term “and/or,” such as “debit title name and/or credit title name,” is often used in the present invention and/or its one or more embodiments, this term expresses a meaning that includes either one of the two cases and a meaning that includes both cases. Additionally, “ID” mentioned in the present invention and/or its one or more embodiments denotes an identifier, and is a concept including expressions, which become distinguishable by enumerating numbers, letters, or signs, or a concept including signals.

It also includes distinguishable letters, and therefore, the standard title name itself is also a concept included in the standard title ID. Additionally, the debit title name and/or the credit title name is included in the related-party accounting journalization file, and is a concept including a title code given to be recognizable with respect to these.

Additionally, “linking” mentioned in the present invention and/or its one or more embodiments denotes combining the standard title ID with the debit title name and/or the credit title name included in the related-party standardization file. More specifically, it is a concept meaning a state in which the standard title ID with respect to the debit title name and/or the credit title name can be easily obtained by creating data in which the debit title name and/or the credit title name has been correlated with the standard title ID included in the related-party standardization file and by allowing the related-party standardization file to access this data. Additionally, the debit title name and/or the credit title name to which the standard title ID has been linked for each related party or a combination of the standard title ID therewith is referred to as a linkage title, and the debit title name and/or the credit title name to which the standard title ID has been linked in a state straddling a plurality of related parties or a combination of the standard title ID therewith is referred to as a matched title.

Additionally, with regard to operations of the first embodiments of the present invention, in the accounting journalization file data standardization system arranged as above, if a correlated linkage title has not been retrieved by the related-party title search unit, the standard title search unit of the title matching processing unit will search for a matched title that has already been provided with a standard title ID from the matched title information database, and the standard title ID of a correlated matched title will be linked to the debit title name and/or the credit title name included in the related-party standardization file.

This processing is completed, and, as a result, even if it is a debit title name and/or a credit title name used in a related-party standardization file for the first time, if it is the same as a debit title name and/or a credit title name included in another related-party standardization file and if a standard title ID has already been linked thereto, a standard title ID that is the same as that standard title ID will be linked thereto.

In the second embodiments of the present invention, an accounting journalization file data standardization system is characterized in that, in the accounting journalization file data standardization system according to the first embodiments of the present invention, the file data placement standardization unit searches for enumerating data included in the related-party accounting journalization file in accordance with the related-party data placement structure, and thereafter generates and outputs a related-party standardization file in which a data item and a data position of a standard data placement structure desirably predetermining the data item and the data position of the accounting journalization file and each piece of data included in the enumerating data are combined together instead of the data item and the data position of the related-party data placement structure.

With regard to operations of the second embodiments of the present invention, in the accounting journalization file data standardization system arranged as above, the file data placement standardization unit combines each piece of data included in the enumerating data of the related-party accounting journalization file with the standard data placement structure instead of the operation in which the file data placement standardization unit reads out a related-party data placement structure corresponding to a specification that has created the related-party accounting journalization file when a related-party accounting journalization file is read in, and thereafter searches for enumerating data included in the related-party accounting journalization file, and combines the related-party data placement structure with each piece of data included in the enumerating data among the operations of the first embodiments of the present invention. In other words, with regard to operations of the second embodiments of the present invention, a placement change from the related-party data placement structure to the standard data placement structure is performed. Therefore, in the second embodiments of the present invention, it becomes a related-party standardization file in which each piece of data included in the enumerating data is converted into the standard data placement structure unlike a related-party standardization file in which pieces of information about enumerating data, data items, and data positions are combined together without changing the related-party data placement structure as in the first embodiments of the present invention. Likewise, in this case, the invention has an operation in which the file data placement standardization unit generates the related-party standardization file.

In the third embodiments of the present invention, an accounting journalization file data standardization system is characterized in that, in the accounting journalization file data standardization system according to the first or second embodiments of the present invention, a standard title information database that stores the standard title name and a standard title ID corresponding to the standard title name is provided, and the title matching processing unit includes an extraction title linkage processing unit that links the standard title ID of the standard title name desirably correlated while searching for the standard title information database with respect to the debit title name and/or the credit title name that has not been retrieved by the standard title search unit or links a standard title ID of a new standard title name desirably correlated with respect thereto and that stores resultant data in the matched title information database as a matched title and/or in the related-party title information database as a linkage title.

With regard to operations of third embodiments of the present invention, in the accounting journalization file data standardization system arranged as above, when the standard title search unit was not able to retrieve a correlated matched title, the extraction title linkage processing unit included in the title matching processing unit links the standard title ID of the desirably correlated standard title name while searching for the standard title information database or links the standard title ID of a desirably correlated new standard title name, and stores resultant data in the matched title information database as a matched title and/or in the related-party title information database as a linkage title, in addition to the operation of the first or second embodiments of the present invention.

In the fourth embodiments of the present invention, an accounting journalization file data standardization program is a program executed to standardize accounting journalization file data in order to perform account processing common to each related party by use of accounting journalization files from a plurality of related parties by means of a computer, and the program includes a file data placement information storage step of storing a data placement structure relative to data items and data positions of accounting journalization files created by a plurality of specifications differing from each other in a file data placement information database, an accounting journalization file read-in step of reading in a related-party accounting journalization file, a data placement structure search step of reading out a related-party data placement structure corresponding to the specification that has created the related-party accounting journalization file from the file data placement information database and searching for enumerating data included in the related-party accounting journalization file in accordance with the related-party data placement structure, a file data placement standardization step of generating and outputting a related-party standardization file in which the data item and the data position of the related-party data placement structure and each piece of data included in the enumerating data are combined together, giving a standard title ID regarding a predetermined desired debit title name and/or a credit title name as a standard title name, a related-party title information database that stores a linkage title in which the standard title ID of the standard title name desirably correlated is linked to the debit title name and/or the credit title name of the data items of the related-party standardization file, a matched title information database that collects linkage titles in each of which the standard title ID of the standard title name desirably correlated is linked to the debit title name and/or the credit title name of the data items of the related-party standardization files and that stores these linkage titles as matched titles, and a title matching processing step of linking the standard title ID of the standard title name desirably correlated is linked to the debit title name and/or the credit title name of the data items of the related-party standardization files, in which the title matching processing step includes a debit/credit title extraction step of extracting a debit title name and/or a credit title name of data items from the related-party standardization file, a related-party title search step of searching for a linkage title to which the standard title ID stored in the related-party title information database has been linked while using the debit title name and/or the credit title name extracted at the debit/credit title extraction step as a key, and a standard title search step of searching for a matched title in which the standard title ID stored in the matched title information database is linked to debit title names and/or credit title names that have not been retrieved at the related-party title search step while using these title names as keys and of linking the standard title ID of the matched title to the debit title names and/or the credit title names that have not been retrieved at the related-party title search step, and the program allows the computer to execute these steps.

The accounting journalization file data standardization program arranged as above is an application of the accounting journalization file data standardization system according to the first embodiments of the present invention, which is embodied as a program, and therefore, its operation is the same as that of the first embodiments of the present invention as described above.

In the fifth embodiments of the present invention, an accounting journalization file data standardization program is characterized in that, in the accounting journalization file data standardization program according to the fourth embodiments of the present invention, the file data placement standardization step is a step of generating and outputting a related-party standardization file in which a data item and a data position of a standard data placement structure desirably predetermining the data item and the data position of an accounting journalization file and each piece of data included in the enumerating data are combined together instead of the data item and the data position of the related-party data placement structure.

The accounting journalization file data standardization program arranged as above is an application of the accounting journalization file data standardization system according to the second embodiments of the present invention, which is embodied as a program, and therefore, its operation is the same as that of the second embodiments of the present invention.

In the sixth embodiments of the present invention, an accounting journalization file data standardization program is characterized in that, in the accounting journalization file data standardization program according to the fourth or fifth embodiments of the present invention, a standard title information database that stores the standard title name and a standard title ID corresponding to the standard title name is provided, and the title matching processing step includes an extraction title linkage processing step of linking the standard title ID of the standard title name desirably correlated while searching for the standard title information database with respect to the debit title name and/or the credit title name that has not been retrieved at the standard title search step or linking a standard title ID of a new standard title name desirably correlated with respect thereto, and of storing resultant data in the matched title information database as a matched title and/or in the related-party title information database as a linkage title.

The accounting journalization file data standardization program arranged as above is an application of the third embodiments of the present invention, which is embodied as a program, and therefore, its operation is the same as that of the invention described in the third embodiments of the present invention.

An audit system according to the seventh embodiments of the present invention includes the accounting journalization file data standardization system according to any one of the first to third embodiments of the present invention, and has a title total balance calculation unit that reads out a related-party standardization file from the accounting journalization file data standardization system and calculates a title total balance for a desirably determined period for each debit title and each credit title included in the related-party standardization file, a balance checkup database that stores balance checkup items desirably determined to make an audit checkup with respect to a title total balance of each debit title and of each credit title, and a title balance checkup execution unit that reads out the title total balance from the title total balance calculation unit, thereafter reads out the balance checkup item from the balance checkup database, thereafter collates the title total balance of each debit title and of each credit title with respect to the balance checkup item, thereafter extracts at least a correlated balance checkup item and a debit title name or a credit title name, and readably stores an extracted item and an extracted name in the balance checkup database as balance checkup results.

With regard to operations of the seventh embodiments of the present invention, the aforementioned audit system reads out a related-party standardization file standardized by the accounting journalization file data standardization system according to any one of the first to third embodiments of the present invention, thereafter provides a balance checkup item with respect to a title total balance for a desirably determined period for each debit title and each credit title while calculating the title total balance, thereafter collates the title total balance, and extracts at least a correlated balance checkup item and a correlated debit title name or a correlated credit title name. More specifically, with regard to operations of the invention, this audit system uses a related-party standardization file obtained by standardizing a related-party accounting journalization file monthly or weekly, and, in a journalizing operation, makes a checkup whether the debit amount or the credit amount of each account title has been entered wrongly or not, or whether an important transaction has occurred or disappeared in terms of the tax code, or whether an omission has occurred or not in the issue of a slip.

In the claims of the present invention and the description, although there are a cases in which a debit title or a credit title is mentioned and a debit title name or a credit title name is mentioned, the debit title name or the credit title name denotes a title name itself such as “cash,” “lease expense,” “accounts receivable,” or “communication charges,” whereas the debit title or the credit title is a concept to mean the contents of journalization including the debit amount and the credit amount in addition to those title names.

An audit system according to the eighth embodiments of the present invention includes the accounting journalization file data standardization system according to any one of the first to third embodiments of the present invention, and has an accounting journalization totalization unit that reads out a related-party standardization file from the accounting journalization file data standardization system, thereafter totalizes related-party accounting journalization included in the related-party standardization file for a desirably determined period, and generates accounting journalization information, a title checkup database that stores title checkup items desirably determined to make an audit checkup with respect to the accounting journalization information, and a title checkup execution unit that reads out the accounting journalization information from the accounting journalization totalization unit, thereafter reads out the title checkup item from the title checkup database, thereafter collates the accounting journalization information with respect to the title checkup item, thereafter extracts at least a correlated title checkup item and a piece of accounting journalization information, and readably stores an extracted item and an extracted piece of information in the title checkup database as title checkup results.

With regard to operations of the eighth embodiments of the present invention, the audit system arranged as above generates accounting journalization information for a desired period, thereafter provides a title checkup item with respect to this accounting journalization information, thereafter collates the accounting journalization information, and extracts at least a correlated title checkup item and a piece of accounting journalization information. More specifically, this audit system has an operation in which it is checked whether the contents of journalization of each account title itself have been entered wrongly or not in a journalizing operation in the same way as in the seventh embodiments of the present invention.

An audit system according to the ninth embodiments of the present invention includes the accounting journalization file data standardization system according to any one of the first to third embodiments of the present invention, and has a title total balance calculation unit that reads out a related-party standardization file from the accounting journalization file data standardization system and calculates a title total balance for a desirably determined period and a title closing total balance in each year of closing of accounts for each debit title and each credit title included in the related-party standardization file, an accounting journalization totalization unit that totalizes related-party accounting journalization included in the related-party standardization file for a desirably determined period and generates accounting journalization information, and a closing audit processing unit that reads out the title total balance and the title closing total balance from the title total balance calculation unit, thereafter reads out the accounting journalization information from the accounting journalization totalization unit, thereafter collates the title total balance and/or the title closing total balance and/or the accounting journalization information with respect to verification items desirably determined to make an audit checkup, and extracts at least a correlated verification item.

With regard to operations of the ninth embodiments of the present invention, in the audit system arranged as above, a title closing total balance is calculated in each year of closing of accounts, and a verification item with respect thereto is provided along with accounting journalization information, and the title closing total balance and the accounting journalization information are collated, and a correlated verification item is at least extracted. More specifically, the ninth embodiments of the present invention has an operation in which a verification item required to perform a closing audit is checked unlike the audit system according to the seventh and eight embodiments of the present invention.

An audit program according to the tenth embodiments of the present invention includes the accounting journalization file data standardization program according to any one of the fourth to sixth embodiments of the present invention, and the audit program is a program executed to perform audit processing common to each of a plurality of related parties by means of a computer by use of a related-party standardization file obtained by execution of the accounting journalization file data standardization program, and the audit program allows the computer to execute a title total balance calculation step of reading out the related-party standardization file and calculating a title total balance for a desirably determined period for each debit title and each credit title included in the related-party standardization file, and a title balance checkup execution step of reading out the balance checkup item from a balance checkup database that readably stores balance checkup items desirably determined to make an audit checkup with respect to a title total balance of each debit title and of each credit title, thereafter collating the title total balance of each debit title and of each credit title with respect to the balance checkup item, thereafter extracting at least a correlated balance checkup item and a debit title name or a credit title name, and readably storing an extracted item and an extracted name in the balance checkup database as balance checkup results.

The audit program arranged as above is an application of the audit system according to the seventh embodiments of the present invention, which is embodied as a program, and therefore, its operation is the same as that of the seventh embodiments of the present invention.

An audit program according to the eleventh embodiments of the present invention includes the accounting journalization file data standardization program according to any one of the fourth to sixth embodiments of the present invention, and the audit program is a program executed to perform audit processing common to each of a plurality of related parties by means of a computer by use of a related-party standardization file obtained by execution of the accounting journalization file data standardization program, and the audit program allows the computer to execute an accounting journalization totalization step of totalizing related-party accounting journalization included in the related-party standardization file for a desirably determined period and generating accounting journalization information, and a title checkup execution step of reading out the title checkup item from a title checkup database that readably stores title checkup items desirably determined to make an audit checkup with respect to the accounting journalization information, thereafter collating the accounting journalization information with respect to the title checkup item, thereafter extracting at least a correlated title checkup item and a piece of accounting journalization information, and readably storing an extracted item and an extracted piece of information in the title checkup database as title checkup results.

The audit program arranged as above is an application of the audit system according to the eight embodiments of the present invention, which is embodied as a program, and therefore, its operation is the same as that of the eighth embodiments of the present invention.

An audit program according to the twelfth embodiments of the present invention includes the accounting journalization file data standardization program according to any one of the fourth to sixth embodiments of the present invention, and the audit program is a program executed to perform audit processing common to each of a plurality of related parties by means of a computer by use of a related-party standardization file obtained by execution of the accounting journalization file data standardization program, and the audit program allows the computer to execute a title total balance calculation step of reading out the related-party standardization file and calculating a title total balance for a desirably determined period and a title closing total balance in each year of closing of accounts for each debit title and each credit title included in the related-party standardization file, an accounting journalization totalization step of totalizing related-party accounting journalization included in the related-party standardization file for a desirably determined period and generating accounting journalization information, and a closing audit processing step of collating the title total balance and/or the title closing total balance and/or the accounting journalization information with respect to verification items desirably determined to make an audit checkup and extracting at least a correlated verification item.

The audit program arranged as above is an application of the audit system according to the ninth embodiments of the present invention, which is embodied as a program, and therefore, its operation is the same as that of the ninth embodiments of the present invention.

In the accounting journalization file data standardization system according to the first embodiments of the present invention, the standardization unit creates a related-party standardization file in which each piece of data of enumerating data included in each accounting journalization file created by different specifications at a plurality of related parties (a concept including a head office, branch offices, departments of a business enterprise, offices at which tax/account services are performed, and clients thereof) is combined with information about a certain type of data placement structure, and, as a result, it is possible to understand the contents of each piece of data including the data item and the data position of accounting journalization files created by the different specifications, and therefore, it is possible to standardize the accounting journalization files created by the different specifications. Therefore, it is possible to commonly heighten the accuracy of all accounting journalization files. In other words, if the file is a standardized accounting journalization file (related-party standardization file), subsequent tax/account processing can be executed even if this processing is commonly performed, and processing that has uniformity and high accuracy can be performed.

Additionally, advantageously, account title names (debit title names and/or credit title names) included in data items can be standardized in addition to the data placement structure.

Data including account title names can be standardized, and therefore, subsequent tax/account processing can be unified, and common processing can be applied. Therefore, a uniform and highly accurate service relative to tax account processing can be provided by use of accounting journalization files from different related parties.

The title matching processing unit performs a central role to fulfill this effect, and this unit includes the related-party title search unit, and debit title names or credit title names included in the related-party standardization file are extracted by this related-party title search unit, and a linkage title can be retrieved from the related-party title information database while using these title names as keys. Therefore, the related-party title information database is provided, and a standard title ID desirably predetermining a debit title name or a credit title name used by each related party is linked here so as to be manageable by use of the standard title ID at each related party, and, as a result, this makes it possible to save effort and time to make a search for debit title names or credit title names of a plurality of different related parties one by one.

Additionally, the title matching processing unit includes the standard title search unit, and therefore, debit title names or credit title names are standardized by a so-called two-step structure in which a search is made for the matched title from the matched title information database when the related-party title search unit cannot make a search. If only the related-party title information database is provided, there will be a case in which a debit title name or a credit title name that is absent in the related-party title information database is included in the related-party standardization file, and, in that case, it cannot be found in spite of a search for the related-party title information database, and therefore, a search is made for the matched title information database in which linkage titles that have been given standard title IDs while straddling the related parties and that have been collected are stored as matched titles.

This standardization of debit title names or credit title names by means of the two-step structure makes it possible to make the laborious effort even smaller and to shorten labor time while further facilitating the management of each related party.

Advantageously, in the accounting journalization file data standardization system according to the second embodiments of the present invention, the data placement structure becomes a desirably determined standard data placement structure, and therefore, the data structure of the related-party standardization file is unified, and the contents thereof are easily understood, in addition to the effect of the first embodiments of the present invention. In the first embodiments of the present invention, although the data placement structure is the one inherent in the accounting journalization file of a related party, the uniformity or commonalization of data is persistently advanced by changing the data placement to a standard in the second embodiments of the present invention, and, advantageously, the handling of a user is improved, and the false recognition of data or the like is reduced, and accuracy is heightened.

In the accounting journalization file data standardization system according to the third embodiments of the present invention, the standard title information database and the extraction title linkage processing unit are provided in consideration of a case in which a correlated matched title has not been retrieved by the standard title search unit, and, as a result, a standard title ID of a standard title name desirably correlated is linked, or a standard title ID of a new standard title name desirably correlated is linked without using the standard title information database, and resultant data can be stored in the matched title information database as a matched title and/or in the related-party title information database as a linkage title, in addition to the effect of the first or second embodiments of the present invention. Therefore, a desirably predetermined standard title ID is given to a debit title name or a credit title name that has never been entered at any related party, and can be processed as a matched title or a linkage title, and, after all, a debit title name or a credit title name that is present in the related-party standardization file for the first time can be standardized. In other words, a standard title ID can be given to a debit title name or a credit title name regardless of the type or kind of that title name, and it can be standardized.

The accounting journalization file data standardization program according to the fourth embodiments of the present invention is an application of the accounting journalization file data standardization system according to the first embodiments of the present invention, which is embodied as a program, and therefore, its effect is the same as that of the first embodiments of the present invention.

The accounting journalization file data standardization program according to the fifth embodiments of the present invention is an application of the accounting journalization file data standardization system according to the second embodiments of the present invention, which is embodied as a program, and therefore, its effect is the same as that of the second embodiments of the present invention.

The accounting journalization file data standardization program according to the sixth embodiments of the present invention is an invention regarding the accounting journalization file data standardization system according to the third embodiments of the present invention, which is embodied as a program, and therefore, its effect is the same as that of the third embodiments of the present invention.

In the audit system according to the seventh embodiments of the present invention, the title total balance for a desired period is calculated for each debit title and/or each credit title by use of the related-party standardization file that standardizes each accounting journalization file created by different specifications at a plurality of related parties, and therefore, even if those are data items or data positions based on different specifications at a plurality of related parties, it is possible to commonly calculate the title total balance and to check whether the balance is suitable or not, or whether an important transaction has occurred or disappeared in terms of the tax code, or whether an omission has occurred or not in the issue of a slip. It is possible to efficiently and highly accurately make a title balance checkup.

In the audit system according to the eighth embodiments of the present invention, it is possible to commonly check whether accounting journalization information is suitable or not in the same way as in the seventh embodiments of the present invention. In other words, it is possible to efficiently and highly accurately check whether the contents of accounting journalization information are suitable or not.

In the audit system according to the ninth embodiments of the present invention, closing of accounts can be efficiently and highly accurately verified and audited in each year of closing of accounts in the same way as in the seventh or eighth embodiments of the present invention by use of the related-party standardization file that has already been standardized.

The audit program according to the tenth embodiments of the present invention is an application of the audit system according to the seventh embodiments of the present invention, which is embodied as a program, and therefore, its effect is the same as that of the seventh embodiments of the present invention.

The audit program according to the eleventh embodiments of the present invention is an application of the audit system according to the eighth embodiments of the present invention, which is embodied as a program, and therefore, its effect is the same as that of the eighth embodiments of the present invention.

The audit program according to the twelfth embodiments of the present invention is an application of the audit system, which is embodied as a program, and therefore, its effect is the same as that of the ninth embodiments of the present invention.

Other aspects and advantages of the invention will be apparent from the following description and the appended claims

### BRIEF DESCRIPTION OF DRAWINGS

FIG. 1 is a conceptual diagram that represents an arrangement of an accounting journalization file data standardization system according to a first embodiment of the present invention.

FIG. 2 is a flowchart showing the flow of data processing in the accounting journalization file data standardization system according to the first embodiment of the present invention.

FIG. 3 is a conceptual diagram showing one example of a data structure of a related-party accounting journalization file processed by the accounting journalization file data standardization system according to the first embodiment of the present invention.

FIG. 4 is a conceptual diagram showing one example of a data input screen (interface screen) by means of a file read-in setting unit of the accounting journalization file data standardization system according to the first embodiment of the present invention.

FIG. 5 is a conceptual diagram showing one example of a specification standard of a data placement structure input by the file read-in setting unit of the accounting journalization file data standardization system according to the first embodiment of the present invention.

FIG. 6 is a conceptual diagram showing an example of a data placement structure of a related-party standardization file that has been subjected to placement standardization processing along a related-party data placement structure by means of the file data placement standardization unit of the accounting journalization file data standardization system according to the first embodiment of the present invention.

FIG. 7 is a conceptual diagram showing an example of a data placement structure of a related-party standardization file that has been subjected to placement standardization processing along a standard data placement structure by means of the file data placement standardization unit of the accounting journalization file data standardization system according to the first embodiment of the present invention.

FIG. 8 is a conceptual diagram showing one example of a data structure of a linkage title stored in a related-party title information database of the accounting journalization file data standardization system according to the first embodiment of the present invention.

FIG. 9 is a conceptual diagram showing one example of a data structure of standard title data stored in a standard title information database and one example of a data structure of a matched title stored in a matched title information database of the accounting journalization file data standardization system according to the first embodiment of the present invention.

FIG. 10 is a conceptual diagram showing one example of an input screen (interface screen) from a user when an extraction title linkage processing unit of the accounting journalization file data standardization system according to the first embodiment of the present invention gives a standard title ID of a desirably correlated standard title name and stores it in the matched title information database as a matched title.

FIG. 11 is a conceptual diagram of an audit system according to a second embodiment of the present invention.

FIG. 12 is a flowchart showing the flow of the data processing of a monthly audit in a traveling audit processing unit of the audit system according to the second embodiment of the present invention.

FIG. 13 is a flowchart showing the flow of the data processing of a closing audit in a closing audit processing unit of the audit system according to the second embodiment of the present invention.

FIG. 14 is a conceptual diagram showing an example of title monthly total balance data including a title total balance calculated for each account title generated by a title total balance calculation unit of the audit system according to the second embodiment of the present invention.

FIG. 15 is a conceptual diagram showing one example of a data input screen (interface screen) when balance checkup item data are generated in the audit system according to the second embodiment of the present invention.

FIG. 16 is a list specifically showing the contents of items included in the balance checkup item data in the audit system according to the second embodiment of the present invention.

FIG. 17 is a list specifically showing the contents of data included in the balance checkup result data in the audit system according to the second embodiment of the present invention.

FIG. 18 is a conceptual diagram showing one example of a data input screen (interface screen) when title checkup item data are generated in the audit system according to the second embodiment of the present invention.

FIG. 19 is a list specifically showing the contents of items included in the title checkup item data in the audit system according to the second embodiment of the present invention.

FIG. 20 is a list showing a specific example of the contents of data included in title checkup result data in the audit system according to the second embodiment of the present invention.

### DETAILED DESCRIPTION

One or more embodiments of the claimed invention will be explained below while referring to figures.

### Embodiment 1

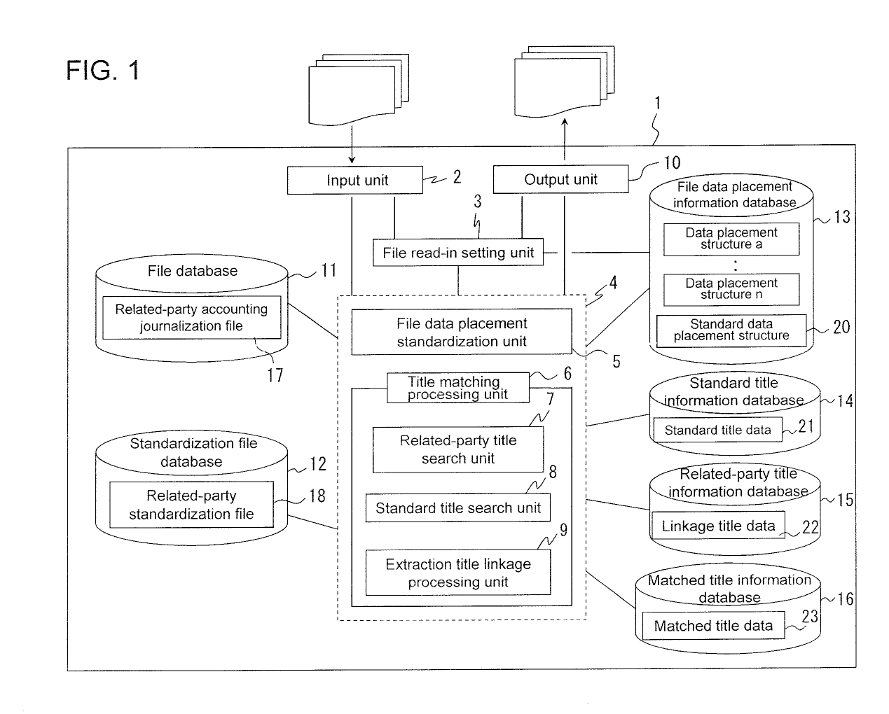

An accounting journalization file data standardization system according to Embodiment 1 (hereinafter referred to as “the first embodiment”) of the present invention will be hereinafter described with reference to FIG. 1 to FIG. 10. (Corresponding to the invention described in claims 1 to 6 in particular.)

FIG. 1 is a conceptual diagram of the accounting journalization file data standardization system according to the first embodiment of the present invention.

In FIG. 1, the accounting journalization file data standardization system 1 is composed of an input unit 2, a file read-in setting unit 3, an arithmetic unit 4, an output unit 10 and a file database 11 serving as a database group, a standardization file database 12, a file data placement information database 13, a standard title information database 14, a related-party title information database 15, and a matched title information database 16.

In the input unit 2, various pieces of information, such as files or data, are readably pre-input into a database or are input thereinto at any time during searching or processing, for example, in such a way that data about the data placement structure of an accounting journalization file set by the file read-in setting unit 3 of the accounting journalization file data standardization system 1 are input thereinto or in such a way that a related-party accounting journalization file 17 that is read and subjected to standardizing processing by a file data placement standardization unit 5 of the arithmetic unit 4 is read. In one or more embodiments of the present invention, the aggregate of pieces of data created along a predetermined specification is referred to as a file, and each piece of information included in the file is referred to as data.

Specific examples of the input unit 2 include plural kinds of devices, such as a keyboard, a mouse, a pen tablet, an optical reader, and a receiver that receives data from an analyzer or a measuring device of a computer or the like through a communication line, which are properly usable depending on a purpose. Alternatively, the input unit 2 may be a device like an interface with respect to the input to the accounting journalization file data standardization system 1.

The output unit 10 is to output information shown on, for example, an input screen (interface screen) to urge the input of search results or processing results or data from the file read-in setting unit 3, the file data placement standardization unit 5, or a title matching processing unit 6 (a related-party title search unit 7, a standard title search unit 8, an extraction title linkage processing unit 9) to the outside, or is to output data read from each database to the outside. More specifically, examples of employable devices include a display device such as CRT, of liquid crystal, of plasma or of organic EL, an output device such as a printer, and a sending device such as a transmitter to perform transmission to an external device. Needles to say, the output unit 10 may be a device like an interface with respect to the output for transmission to an external device.

The file read-in setting unit 3 is to set and generate data placement structures related to data items and data positions of accounting journalization files that are stored in the file data placement information database 13. This generation of the data placement structures will be described later in detail.

Data placement structures “a” to “n” stored in the file data placement information database 13 correspond to differences in specifications among accounting journalization files, and, for example, correspond to differences in data placement structures generated by the creation of accounting journalization files by use of pieces of each different software, and are stored in the file data placement information database 13 readably as data placement structures different in specification. Moreover, a standard data placement structure 20 that is desirably predetermined by a user or by an administrator of the accounting journalization file data standardization system 1 is stored therein. These data placement structures “a” to “n” and the standard data placement structure 20 may be generated through the file read-in setting unit 3, or those that have been created on the outside may be stored in the file data placement information database 13 through the input unit 2. Alternatively, those may be generated through the file read-in setting unit 3, or may be prepared in the file data placement standardization unit 5 described later without being stored in the file data placement information database 13 through the input unit 2.

The arithmetic unit 4 is composed of the file data placement standardization unit 5 and the title matching processing unit 6.

The file data placement standardization unit 5 processes related-party accounting journalization files 17 collected from a plurality of related parties differing from each other. The standardizing processing of the related-party accounting journalization files 17 denotes the generation of data placement structures included in the different related-party accounting journalization files 17, i.e., is to perforin processing in which information about data items and data positions are read from the file data placement information database 13 for each related-party accounting journalization file 17, and thereafter each piece of data of enumerating data included in the related-party accounting journalization files 17 is linked to the information about data items and data positions, and the files are generated as files in which the relationship between the position of the enumerating data of the related-party accounting journalization file 17 and the kind of the data and its position in the related-party accounting journalization file 17 is recognizable.

The number of methods in which the related-party data placement structure is read out by the file data placement standardization unit 5 is two.

The first method is a method in which pieces of information (identifiers such as IDs, codes, characters, and signs) about which a data placement structure corresponds to a related-party data placement structure are pre-input into the file data placement standardization unit 5 through the input unit 2, and are then read from the file data placement information database 13 because generally speaking, it is possible to know beforehand about the specifications of a software company by which the related-party accounting journalization file 17 has been created. In other words, this method is to receive the input of information about the related-party data placement structure from the input unit 2 and then allow the file data placement standardization unit 5 to read it from the file data placement information database 13.

The second method is a method in which the file data placement standardization unit 5 reads the related-party accounting journalization file 17 that is input from the input unit 2 or that has been stored in the file database 11, thereafter searches for its internal data placement structure, thereafter collates it with a plurality of data placement structures pre-stored in the file data placement information database 13, and reads out a matched one of the data placement structures as a related-party data placement structure. The following five methods can be considered as a collation method performed by the file data placement standardization unit 5, and any one of the five methods may be employed, or, even if a method exclusive of the five methods is employed, it is required of the file data placement standardization unit 5 to be capable of automatically reading out a related-party data placement structure.

(1) A method in which pieces of data of the related-party accounting journalization file 17 are applied to data positions of a plurality of data placement structures, respectively, and it is checked whether these are kinds (numerical values or texts) of data to be entered in data items of the data placement structures.

(2) A method in which pieces of data of the related-party accounting journalization file 17 are applied to data positions of a plurality of data placement structures, respectively, and it is checked whether a specific piece of data of the related-party accounting journalization file 17 is applicable to a specific data item of the data placement structures. More specifically, this is a method in which it is checked whether data about “slip number” of the related-party accounting journalization file 17 agrees with the position of the data item concerning the “slip number” of the data placement structures, and, “date,” “debit title name,” and “credit title name” are employable besides the “slip number”.

(3) A method in which the position of a blank column or a blank row included in the related-party accounting journalization file 17 is checked. This is because a characteristic blank column or blank row is made by the specifications of software or the like, and therefore, the software that has created the related-party accounting journalization file 17 can be specified if its position can be located.

(4) A method in which the periodicity of data included in the related-party accounting journalization file 17 is checked. This is because the related-party accounting journalization file 17 is created by inputting journalization about daily slips into software, and therefore, data items, such as “date,” “slip number,” “debit title name,” and “credit title name,” are periodically placed, and a difference in the number of data items or a difference in the placement of data items makes its periodicity characteristic in each piece of software. Therefore, if its periodicity can be understood, software that has created the related-party accounting journalization file 17 can be specified, and its related-party data placement structure can be specified.

(5) In currently used software, information (identifiers such as IDs, codes, characters, and signs) that specifies software by which the related-party accounting journalization file 17 has been created is not included in the related-party accounting journalization file 17, and, if it is included therein, software can be specified by reading out its information, and its related-party data placement structure can be specified.

In this file data placement standardization unit 5, a related-party standardization file 18 is generated and output by using the related-party accounting journalization file 17 and a data placement structure that suits the related-party accounting journalization file 17 stored in the file data placement information database 13. Additionally, the file data placement standardization unit 5 readably stores the related-party standardization file 18 in the standardization file database 12. The related-party standardization file 18 is a file that can recognize the relationship between the position of enumerating data included in the related-party accounting journalization file 17 and the kind of data present at that position.

Additionally, in the file data placement standardization unit 5, the data placement structure included in the related-party accounting journalization file 17 may be read out from the file data placement information database 13, and the pieces of enumerating data included in the related-party accounting journalization file 17 may be permuted in accordance with the standard data placement structure 20 read out from the file data placement information database 13 at the same time as each data item of the enumerating data included in the related-party accounting journalization file 17 is linked to information about the data position. This permutation makes it possible to uniform processing steps and searching steps subsequent to title matching processing that uses the title matching processing unit 6 described later, and makes it possible to shorten processing time and searching time or increase the accuracy of processing. (Corresponding to the invention described in claim 3 in particular.)

In the present specification, the standard data placement structure 20 is arranged to be stored in the file data placement information database 13 and to be read out by the file data placement standardization unit 5, and this may be generated and used through the file read-in setting unit 3 when processing is performed by using the accounting journalization file data standardization system 1 besides the fact that this is read out from the file data placement information database 13 as described above. However, the most efficient method is to prepare it in the file data placement standardization unit 5 itself in advance. In both cases, the pieces of enumerating data included in the related-party accounting journalization file 17 can be permuted.

Next, the title matching processing unit 6 will be described. Although the title matching processing unit 6 is composed of the related-party title search unit 7, the standard title search unit 8, and the extraction title linkage processing unit 9, it may be considered to conceptually employ a case in which the title matching processing unit 6 includes the standard title search unit 8 and the extraction title linkage processing unit 9 or, alternatively, a case in which the title matching processing unit 6 includes neither the standard title search unit 8 nor the extraction title linkage processing unit 9.

The title matching processing unit 6 performs title matching processing with respect to the related-party standardization file 18 that has been subjected to standardizing processing by means of the file data placement standardization unit 5. Before describing the specific contents of this processing, the situation, which is also pointed out by Patent Literatures 1 and 2 as problems, will be described first.

When a small-scale corporation or a sole proprietor inputs accounting data, accounting software is often used, and, during the input, journalizing processing is often performed using so-called double-entry bookkeeping in which the amount on the debit side and the amount on the credit side are entered while entering debit title names and credit title names. However, these small-scale corporation and sole proprietor who do not have special account/tax knowledge often add debit title names and credit title names along the respective business contents and often change those debit title names and credit title names that are originally used as default values in software, and the software is made to allow such an operation, and therefore, in subsequent tax processing or account processing in which financial statements, such as a profit-and-loss statement, a balance sheet, and a cash flow statement are created or audited while using accounting journalization files, there is a need to confirm whether account titles (debit titles and credit titles) are correctly used or include errors or whether the consistency exists among these account titles to be based on the creation of financial statements even if these do not include errors, and therefore, much effort and time have been consumed for the processing and operations.

Therefore, one or more embodiments of the present invention address these issues and to heighten the accuracy of service while uniforming the service so that tax/account processing common to different related parties can be performed.

In the accounting journalization file data standardization system 1 according to the present embodiment, the fact that related-party accounting journalization files 17 submitted from a plurality of different related parties are standardized into related-party standardization files 18 has an extremely important meaning, and debit title names and/or credit title names included in the related-party standardization files 18 are matched with, for example, account title names to be based on the creation of financial statements and are brought into a so-called linked state even if these are not allowed to coincide therewith as standard title names, and, as a result, later account processing, such as tax processing or auditing, becomes extremely easy, and accuracy can be heightened. In one or more embodiments of the present invention, the matching processing is regarded as a part of the standardizing processing.

The standard title name is a desirably pre-set title name, and, as described above, an account title name to be based on the creation of financial statements or a title name used most usually is set as a standard title name of this, and this is correlated with a standard title ID, and, as a result, account processing, such as tax processing or auditing, can easily perform arithmetic processing in a uniform manner.

The contents of title matching processing performed by the title matching processing unit 6 will be described in detail.

First, the related-party title search unit 7 of the title matching processing unit 6 reads out the related-party standardization file 18 from the standardization file database 12. Thereafter, debit title names and credit title names included in the related-party standardization file 18 are extracted, and the linkage title data 22 stored in the related-party title information database 15 are read out while using these title names as keys, and are retrieved, and, if a title is detected by the search, a search is made for the following title. This operation for debit title names and credit title names included in the related-party standardization file 18 is performed.

If there are debit title names or credit title names that have not been detected by the related-party title search unit 7 during the search, the standard title search unit 8 will make a next search as described later.

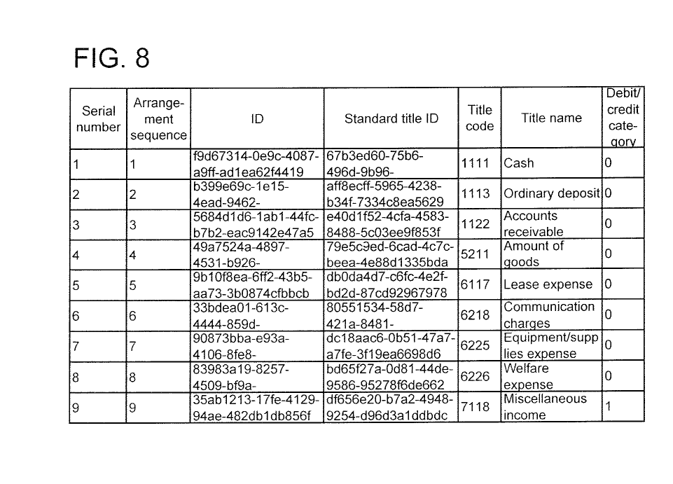

The related-party title information database 15 will be described here. The related-party title information database 15 is a database provided for each related party, and standard title IDs are correlated with debit title names and/or credit title names of each related party, respectively. As described above, this state in which a standard title ID is linked to a credit title name and/or a debit title name is referred to as a linkage. Pieces of linkage title data 22 stored in the related-party title information database 15 are stored in the form of a data structure shown in FIG. 8.

In FIG. 8, the serial number is that of an individual linkage title, and the ID is IDs given to the debit title name and the credit title name of each related party, and is used as the ID of the linkage title of a related party without changes. The standard title ID corresponding to the debit title name or the credit title name of a related party is linked to the right of the ID. Additionally, the title code and the title name of this linkage title are an original title code and an original title name of a related party, and basically depend on each related party or depend on specifications of software or the like of the related party.

In one or more embodiments of the present invention, although the concept of the ID has been described above, for convenience, the ID and the code are distinguished. The ID is peculiarly used in the system or the program of one or more embodiments of the present invention, and is generated by a random number generator or by its function, etc., in the form of 30 digits or more, whereas the code is determined by the convenience of a related party, and, for example, is determined by specifications of software of the related party, and is an identifier that is also used in the system or the program of one or more embodiments of the present invention. Therefore, as described above, the credit title name and/or the debit title name of a related party and the title codes given to them can be regarded as the same, and these can be included in the concept of the credit title name and/or the debit title name.

Additionally, in the present embodiment, although a state in which a standard title ID is linked to a credit title name and/or a debit title name of a related party is referred to as a linkage, and such a title is referred to as a linkage title, only an arithmetic processing is required to be performed, and therefore, if arithmetic processing can be performed by use of a standard title name (text) without using the ID, a linked state that uses a standard title name will also be employable. The same applies to linkage processing with respect to matched title data 23 and extraction titles described later. In contrast, with respect to a credit title name and/or a debit title name of a related party, a standard title ID may be linked to the credit title name and/or the debit title name without giving an ID thereto.

The title matching processing unit 6 composed of the related-party title information database 15 and the related-party title search unit 7 makes it possible to standardize an account title name (debit title name and/or credit title name) included in data items, and makes it possible to standardize data including the account title name, and therefore, it is possible to unify subsequent tax/account processing and to perform processing common thereto.

Therefore, it is possible to provide a homogenous and highly accurate service relative to tax/account processing by using accounting journalization files from a plurality of different related parties.

Thereafter, if the related-party title search unit 7 of the title matching processing unit 6 cannot detect the linkage title data 22 stored in the related-party title information database 15 in spite of a search for the linkage title data 22, the standard title search unit 8 reads out the matched title data 23 stored in the matched title information database 16 and makes a search therefor while using a debit title name and/or a credit title name included in the related-party standardization file 18 as a key.

As a matter of course, if the related-party title search unit 7 cannot detect the linkage title data 22 in spite of a search therefor, it is recommended to construct logic in such a way that, for example, a search command is transmitted to the standard title search unit 8, and the standard title search unit 8 that has received the search command starts a search for the matched title information database 16, as a matter of course.

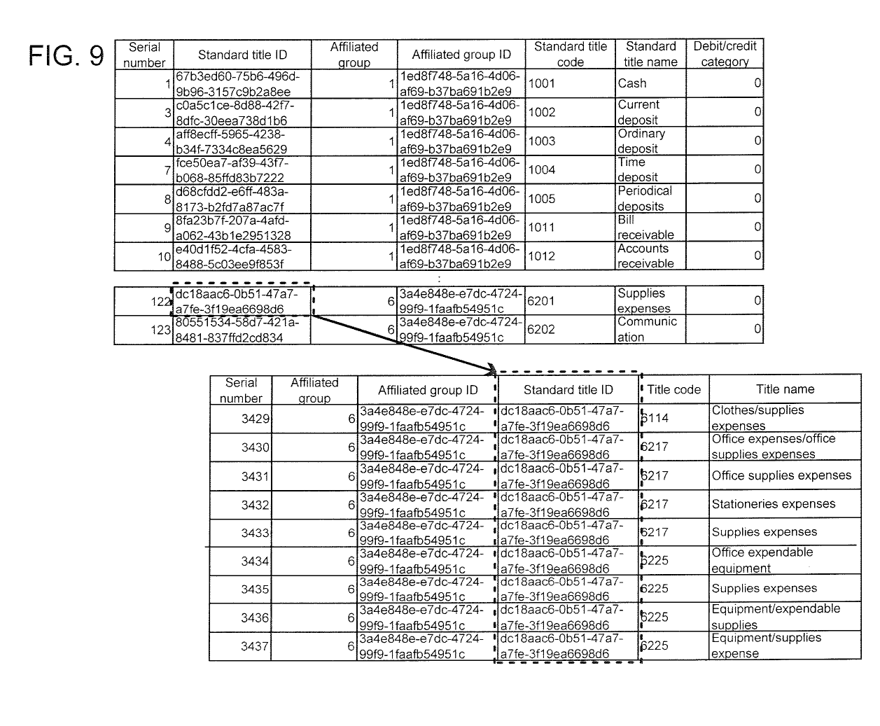

The matched title information database 16 will be described here. The matched title information database 16 is a database provided by collecting the linkage title data 22 of the related-party title information database 15 provided for each related party from all the related parties in the system, and standard title IDs are linked to debit title names and/or credit title names collected from all the related parties. In this matched title information database 16, a linkage title in which the standard title ID is linked to the debit title name and/or the credit title name is referred to as a matched title. The matched title data 23 stored in the matched title information database 16 is stored in the form of a data structure shown as a table at the lower part of FIG. 9.

In the table at the lower part of FIG. 9, the serial numbers are those of individual pieces of matched title data 23, and are an aggregate of all linkage titles. The affiliated group category is a category given to the attribute of a title, and is a category based on an attribute used in, for example, a balance sheet or a profit-and-loss statement. The affiliated group ID is an ID given to the affiliated group category. As shown in the lower table of FIG. 9, different title codes and different title names are displayed in spite of having the common standard title ID (see broken-line parts connected by an arrow between the upper and lower tables of FIG. 9), and, from this, it can be understood that “Standard title name supplies expenses” of “Standard title code 6201” of the standard title data 21 shown in the upper table of FIG. 9 correspond to the title names although different title names are given depending on related parties. The standard title data 21 shown in the upper table of FIG. 9 will be described later.

It is also possible to understand circumstances in which the different title codes and the different title names are those given by each related party, and are variously customized by each related party.

The standard title ID is linked to title codes and to title names, and shows linkage titles of those titles, respectively. An individual title code and an individual title name of the linkage title are an original title code and an original title name of a related party, and are basically different depending on each related party or depending on the specifications of software or the like of the related party.

If the matched title data 23 of the matched title information database 16 can be retrieved in this way, the standard title search unit 8 links the standard title ID linked in the matched title data 23 to debit title names and/or credit title names included in the related-party standardization file 18, and stores these in the related-party title information database 15 of its related party readably as linkage title data 22. Alternatively, linkage titles newly linked to the matched title data 23 are added, and the standard title search unit 8 may store these in the matched title information database 16 or may store these in both databases.

However, if these are stored only in the matched title information database 16 in addition to the matched title data 23, these are not included in the related-party title information database 15 even if the same debit title name or the same credit title name is included in the related-party accounting journalization file, and therefore, a search is again made for the matched title information database 16, and therefore, this is inefficient to some extent.

The title matching processing unit 6 links the standard title ID to debit title names and/or credit title names included in the related-party standardization file 18 in this way.

If the system includes the title matching processing unit 6, it is recommended to allow the file data placement standardization unit 5 to store the related-party standardization file 18 in the standardization file database 12 after completing the linkage in the title matching processing unit 6. The reason is that the completion of linkage processing can be recognized by the presence of the related-party standardization file 18.

If the matched title information database 16 is provided in addition to the related-party title information database 15 in this way and if the standard title search unit 8 is provided in addition to the related-party title search unit 7 in the title matching processing unit 6, the standard title search unit 8 can make a search for a matched title from the matched title information database 16 and can standardize a debit title name or a credit title name when the related-party title search unit 7 cannot make a search.

As described above, in the accounting journalization file data standardization system 1 according to the present embodiment, the related-party title information database 15 is first provided, and, in this database, a debit title name or a credit title name that is used by an individual related party is linked to a desirably predetermined standard title ID so as to be managed while using the standard title ID at the individual related party. This makes it possible to save effort and time to make a search for debit title names or credit title names of a plurality of different related parties one by one, and, if a debit title name or a credit title name that is not found in the related-party title information database is included in the related-party standardization file, a search is made for the matched title information database in which linkage titles that have been given standard title IDs and that have been collected while straddling the related parties are stored as matched titles. The debit title names and the credit title names are standardized by this two-step structure, and, as a result, accounting journalization files of individual related parties can be more easily managed in a standardizing process, and, at the same time, a labor effort is reduced and time is shortened.

Next, the title matching processing unit 6 includes the extraction title linkage processing unit 9 on the assumption that the standard title search unit 8 cannot also make a search for the debit title name and/or the credit title name of a related party in the matched title data 23 of the matched title information database 16.

The extraction title linkage processing unit 9 receives the input of a standard title ID desirably selected from the standard title IDs desirably pre-registered in the standard title information database 14 from the input unit 2, and links the standard title ID to the debit title name and/or the credit title name that has not been retrieved in the matched title data 23, and readably stores it in the matched title information database 16 as a matched title. Alternatively, the extraction title linkage processing unit 9 may receive a desired new standard title ID input from the input unit 2, and may link the standard title ID to the debit title name and/or the credit title name that has not been retrieved in the matched title data 23, and may readably store it in the matched title information database 16 as a matched title. Additionally, instead of storing it in the matched title information database 16 as a matched title, or in addition thereto, the extraction title linkage processing unit 9 may readably store it in the related-party title information database 15 concerning the related party as a linkage title. However, if it is not stored in the matched title information database 16 as a matched title, when a new debit title name or a new credit title name is likewise generated at another related party, it is impossible to detect it even if a search is made for the matched title information database 16, and therefore, processing must be again performed in the extraction title linkage processing unit 9, and this is inefficient, and therefore, it is preferable to store it in the matched title information database 16 as a matched title so that the standard title ID can also be linked at another related party.

In any case, in the extraction title linkage processing unit 9, it is not automatically determined whether any one of the standard title IDs (standard titles) is correlated to the debit title name and/or the credit title name that has not been retrieved by the standard title search unit 8, and therefore, the input about a determination whether any one of the standard title IDs (standard titles) is to be selected is required to be received from a user through the input unit 2 while displaying information about the standard title data 21 to be mentioned as a candidate on the output unit 10 from the standard title information database 14 in which the standard title ID is pre-registered desirably. Alternatively, if a new standard title ID that is not registered in the standard title information database 14 is correlated, there should be a need to receive the input of a new standard title ID itself (standard title) from the input unit 2, for example, by selecting the addition of a new standard title ID on an input screen displayed on the output unit 10.

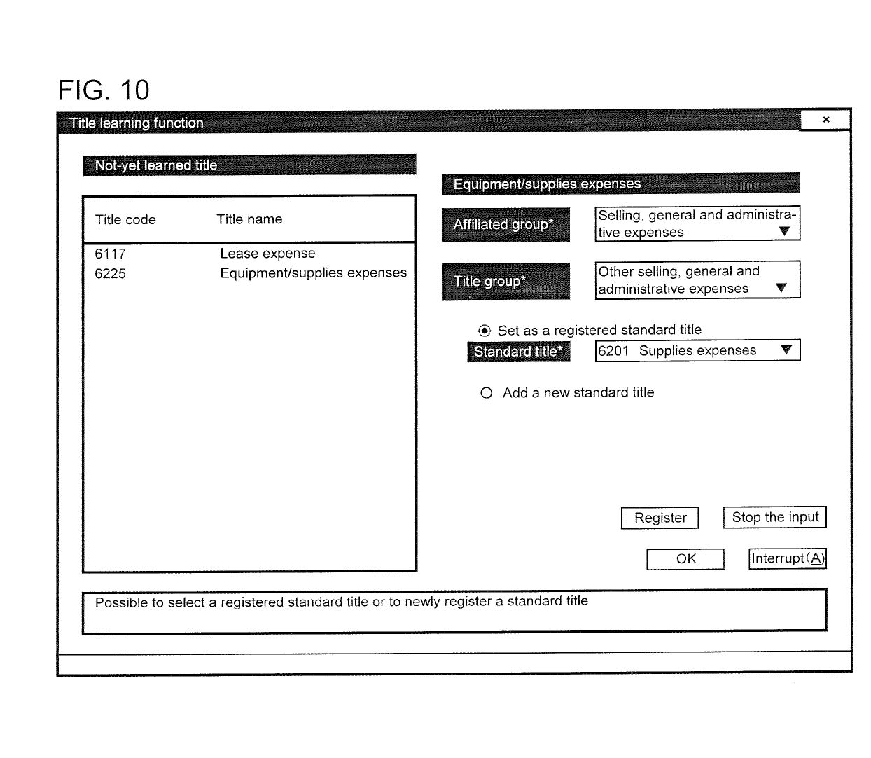

With reference to FIG. 10, a description will be here given of an input screen (interface screen) and an input method for urging the input of data displayed on the output unit 10 by means of the extraction title linkage processing unit 9. FIG. 10 is a conceptual diagram showing one example of an input screen (interface screen) from a user when the extraction title linkage processing unit 9 gives a standard title ID of a standard title name desirably correlated and stores it in the matched title information database 16 as a matched title.

In FIG. 10, “Lease expense” of title code 6117 and “Equipment/supplies expense” of title code 6225 are displayed as not-yet learned titles. This shows that information about titles that have not been retrieved by the standard title search unit 8 in the matched title data 23 of the matched title information database 16 is transmitted to the extraction title linkage processing unit 9, and is displayed on the output unit 10. The user selects “Equipment/supplies expense” (right uppermost column) among the titles displayed here, and reads out the standard title data 21 from the standard title information database 14 with respect thereto, so that this is displayed in the right column. Thereafter, in order to narrow standard titles included in the standard title data 21, “Selling, general and administrative expenses” is selected from the affiliated group column, and “Other selling, general and administrative expenses” is selected from the title group column, and “Supplies expenses” desirably set as a narrowed standard title (standard title code 6201) is selected, and this is set as a standard title corresponding to the equipment/supplies expense of title code 6225. In FIG. 10, “6201” is shown as a standard title code although its standard title ID is not shown.

If a new standard title that is not included in the standard title data 21 of the standard title information database 14 is added, a new standard title ID and a standard title (standard title code) can be input by marking the column “Add a new standard title” near the center of the right column shown in FIG. 10.

The extraction title linkage processing unit 9 receives the input of a standard title and a standard title ID selected from the standard title data 21 of the standard title information database 14 in this way or completely newly receives the input of these ones from the input unit 2, and readably stores a new standard title ID and a standard title (standard title code) in the standard title information database 14 as standard title data 21. The standard title data 21 stored in the standard title information database 14 specifies a correspondence between the standard title and the standard title ID, and therefore, the pieces of data are stored so as to correspond to each other.

Likewise, in this case, the title matching processing unit 6 links the standard title ID to debit title names and/or credit title names included in the related-party standardization file 18 on the matched title data 23.

If the standard title search unit 8 cannot detect the matched title data 23 in spite of a search therefor, it is recommended to construct logic in such a way that, for example, a search command is transmitted to the extraction title linkage processing unit 9, and the extraction title linkage processing unit 9 that has received the search command reads out the standard title data 21 of the standard title information database 14 or displays the input screen shown in FIG. 10 on the output unit 10, as a matter of course.

As can be understood from the foregoing description, this extraction title linkage processing unit 9 is provided, and, as a result, the title matching processing unit 6 can link the desirably predetermined standard title ID of the standard title to a debit title name or a credit title name that has never been entered at any related party, and can process it as a matched title, and, after all, the debit title name or the credit title name that has appeared in the related-party standardization file 18 for the first time can be standardized. In other words, the debit title name or the credit title name can be given a standard title ID and can be standardized even if what kind of name the debit title name or the credit title name has.

As described above, the standard title information database 14 is provided in addition to the related-party title information database 15 and the matched title information database 16, and the title matching processing unit 6 is provided with the extraction title linkage processing unit 9 in addition to the related-party title search unit 7 and the standard title search unit 8, and, as a result, a debit title name or a credit title name can be standardized by allowing the extraction title linkage processing unit 9 to read out data from the standard title information database 14 or by newly selecting a standard title if the related-party title search unit 7 and the standard title search unit 8 cannot make a search. The debit title names and the credit title names are standardized by this three-step structure, and, as a result, accounting journalization files of individual related parties can be more easily managed in a standardizing process, and, at the same time, a labor work can be reduced and the time can be shortened.

Likewise, in a case in which the system includes the title matching processing unit 6 provided with the extraction title linkage processing unit 9, it is recommended to allow the file data placement standardization unit 5 to store the related-party standardization file 18 in the standardization file database 12 after ending the linkage in the title matching processing unit 6 for the aforementioned reason.

The standard title information database 14 will be described here. The standard title information database 14 is a database in which a user or an administrator of the system stores desirably-determined standard title data 21 while treating an account title name used in, for example, financial statements as a base as described above. The standard title data 21 may be predetermined and then be stored directly in the standard title information database 14 through the input unit 2, or the standard title information database 14 may be read out, and pieces of data may be individually input through the input unit 2, for example, by allowing the output unit 10 to display an input screen (interface screen).

One example of a data structure of the standard title data 21 will be described with reference to FIG. 9. As described above, the structure shown at the upper table of FIG. 9 is one example of a data structure of the standard title data 21. The serial number is the one of individual standard title data 21, and the title code and the title name are entered as a standard title code and a standard title name, respectively. The affiliated group category and the affiliated group ID are also given in the same way as the matched title data 23 shown at the lower part of FIG. 9. As a matter of course, the standard title ID is also given.

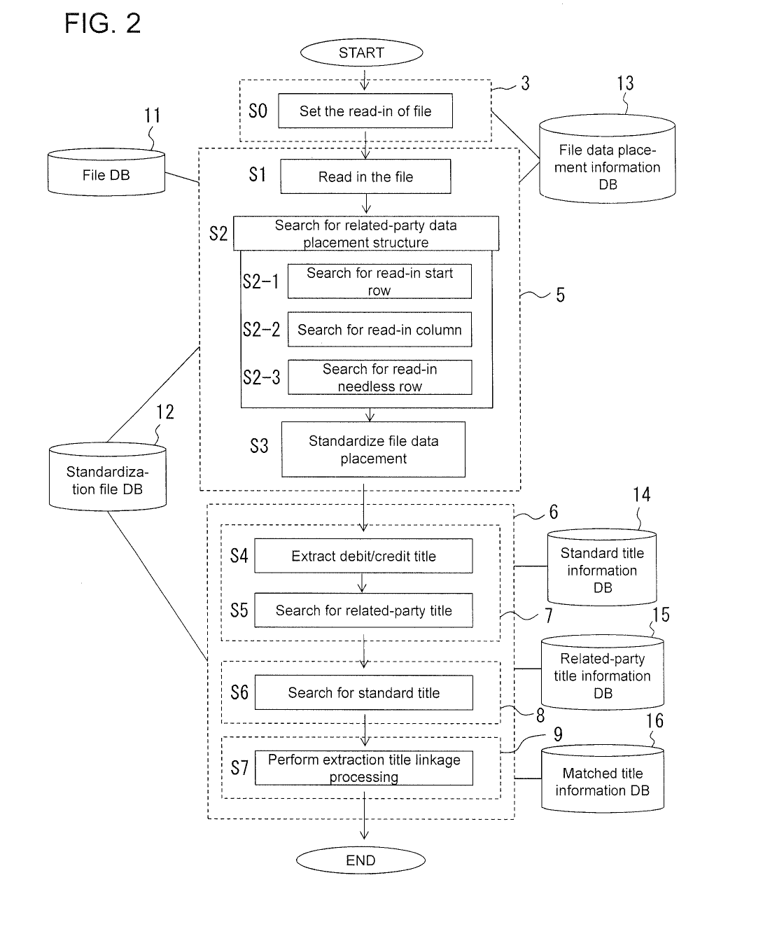

The flow of data processing in the accounting journalization file data standardization system 1 according to the present embodiment will be hereinafter described with reference to FIG. 2 and FIG. 1.

The drawing is a flowchart showing the flow of data processing in the accounting journalization file data standardization system according to the present embodiment. With respect to the accounting journalization file data standardization program of the one or more embodiments of the present invention, the drawing shows its execution steps, and therefore, a description of the flow of data processing in the accounting journalization file data standardization system 1 with reference to this drawing is synonymous with a description of an embodiment of the accounting journalization file data standardization program.

In FIG. 2, step S1 will be first described although there is a file read-in setting step designated as step S0. In FIG. 2, parts shown by the broken line in such a manner as to cover a description of steps are components of the accounting journalization file data standardization system 1 of FIG. 1, and reference signs of these components are the same as those of FIG. 1.

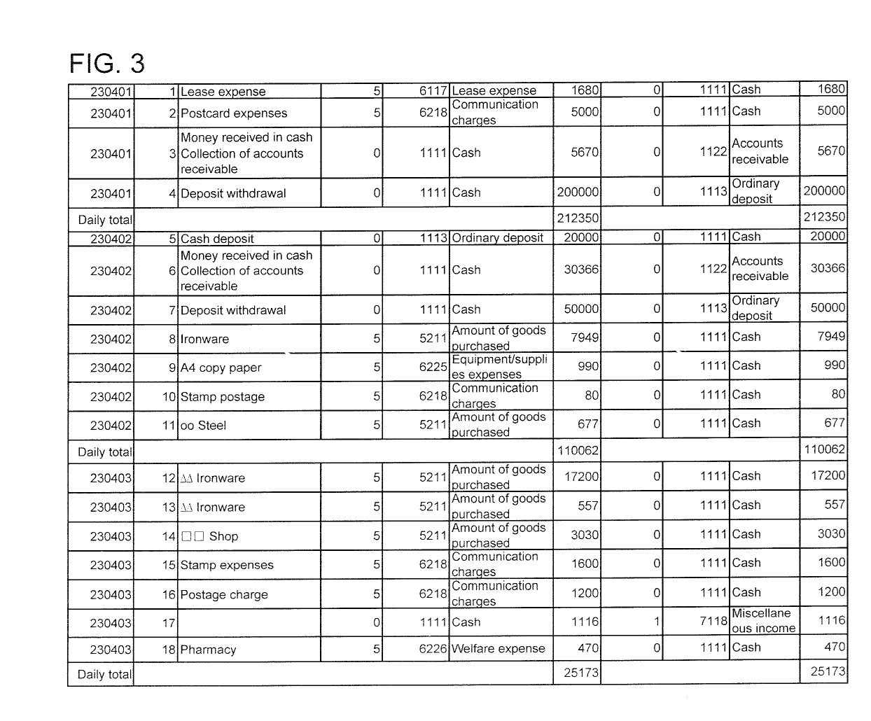

Step S1 is a file read-in step executed by the file data placement standardization unit 5. The file data placement standardization unit 5 reads in the related-party accounting journalization file 17 from the file database 11. The related-party accounting journalization file 17 has a data structure shown in FIG. 3.

In the present embodiment, the related-party accounting journalization file 17 input from the input unit 2 may be directly read in without particularly providing the file database 11 although the file database 11 that readably stores the related-party accounting journalization file 17 is provided.

The data structure of the related-party accounting journalization file 17 shown in FIG. 3 will be described. This is a data structure about journalizing processing in which slips generated by daily business activities by a corporation or of a sole proprietor are totalized every day. In the present embodiment, although pieces of data are arranged in a two-dimensional table manner for an easy understanding, actual pieces of data are enumerated one-dimensionally. However, referring to, for example, FIG. 3, data from the slip date (column of, for example, 230401) to the credit amount (column of, for example, 1680) are enumerated periodically, and therefore, data can also be expressed as the table of FIG. 3 by conceiving its periodicity as rows.

Usually, slip date, slip number, abstract, debit/credit taxation category, debit/credit title code, debit/credit title name, and debit/credit amount are input in the related-party accounting journalization file 17. However, FIG. 3 shows a structure of a crude related-party accounting journalization file 17, and therefore, what is meant by any one of the columns is not clarified.

As described above, a title code is given according to specifications of software or the like that is used by its related party about both the debit and the credit in consideration of double-entry bookkeeping in daily slip processing, and a creator of the related-party accounting journalization file 17 inputs its debit title name and its credit title name while entering an abstract or selecting an abstract whenever slip processing is performed once, thereafter selects and inputs title codes thereof, and inputs the same debit amount and credit amount.

The related-party accounting journalization file 17 that includes this data structure is read in by the file data placement standardization unit 5, so that standardizing processing is started. Based on the specifications according to which the related-party accounting journalization file 17 is created, the file data placement standardization unit 5 reads in a data placement structure “a” that accords with the related-party accounting journalization file 17 from the file data placement information database 13, and the file data placement standardization unit 5 must read in it before executing specific standardizing processing although it is negligible whether the timing thereof is before or after reading in the related-party accounting journalization file 17.

The file data placement standardization unit 5 reads in the data placement structure “a” that accords with the related-party accounting journalization file 17, and therefore, it is possible to understand the relationship between the data position and the data item in the arrangement of data. The data position denotes each position of columns and rows shown in a matrix manner in FIG. 3, whereas the data item denotes items, such as slip date, slip number, abstract, debit/credit title name, etc., which are written at each column of the first row in FIG. 3.

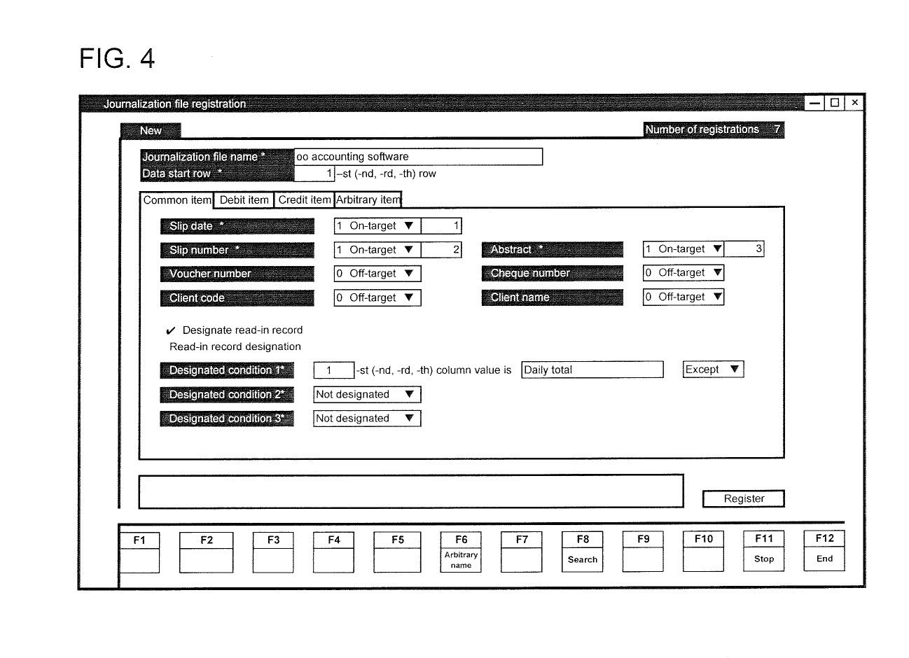

It is recommended to generate and store the data placement structures “a” to “n” readably stored in the file data placement information database 13 by use of the file read-in setting unit 3 as shown at step S0 although the data placement structures may be stored directly from the input unit 2 before using the accounting journalization file data standardization system 1. The file read-in setting unit 3 has an input screen shown in FIG. 4 that can be displayed from the output unit 10 so that the data placement structures “a” to “n” that differ from each other depending on specifications of, for example, different pieces of software can be generated.

As shown in FIG. 4, it is possible to input a journalization file name and then set and register information about the data start row (first row in the figure), information about the position of slip date (first column in the figure), about the position of slip number (second column in the figure), and about the position of abstract (third column in the figure), info cation about read-in record designation (in the figure, data is read in except for a case in which the value in the first column is the daily total), etc.

This input screen is displayed from the output unit 10, and, as a result, the user of this system can easily input information about the data placement structure from the input unit 2. It is recommended to beforehand analyze and obtain these pieces of information that are input with respect the data placement structures in each of the related-party accounting journalization files 17 created with different pieces of software in advance.

The input screen of FIG. 4 shows a case in which a data placement structure concerning a common item is input, and, besides this, it is also possible to input the contents that are input for each debit title and each credit title or the contents that are arbitrarily set and registered as arbitrary items as shown in the figure.

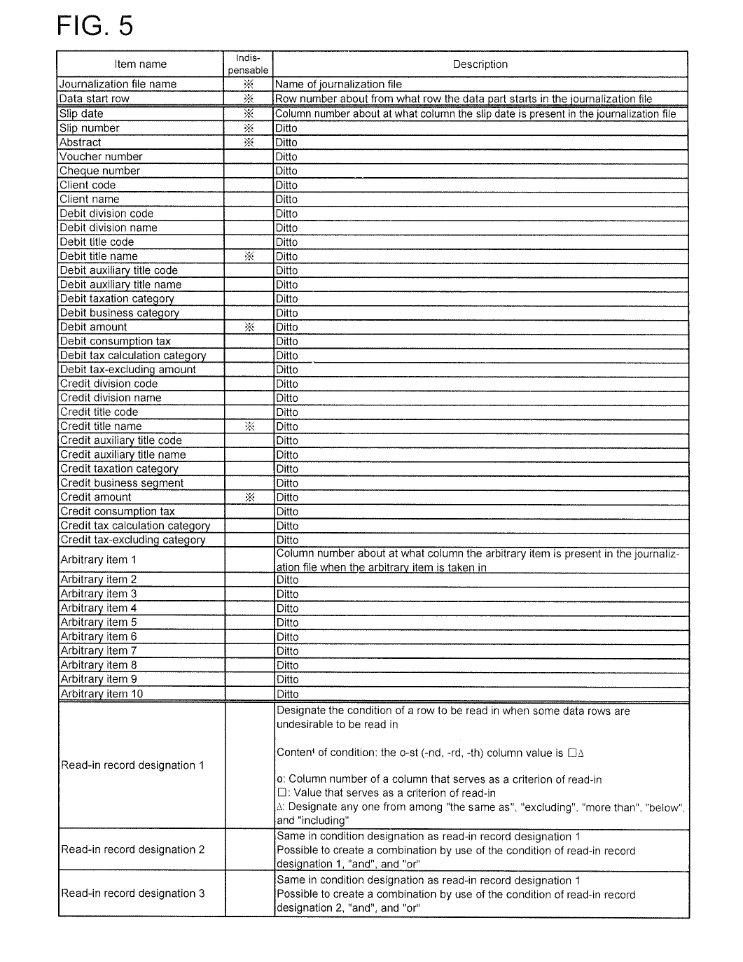

FIG. 5 shows one example of a specification standard of a data placement structure concerning the related-party accounting journalization file 17 that is generated by the file read-in setting unit 3 and that is registered in the file data placement information database 13. Item names shown at the leftmost column in the list are item names asked on the input screen of FIG. 4 shown above. More specifically, those are journalization file name, data start row, slip date, slip number, abstract, etc. A specification standard concerning the data position about debit and credit titles is also included, and a specification standard is included in an arbitrary item, in addition to the common items as described above. Additionally, the list includes a specification standard concerning the read-in record designation, such as the read-in record concerning the daily total described with reference to FIG. 4 is not necessary.

The data placement structures “a” to “n” are beforehand understood in each of the different software companies in this way in advance, and these are stored in the file data placement information database 13, and, when a related-party accounting journalization file 17 using the software of a software company is standardized, a data placement structure that accords with the software is read out, and a data item meant by enumerated data included in the related-party accounting journalization file 17 and each data position can be understood by this data placement structure.

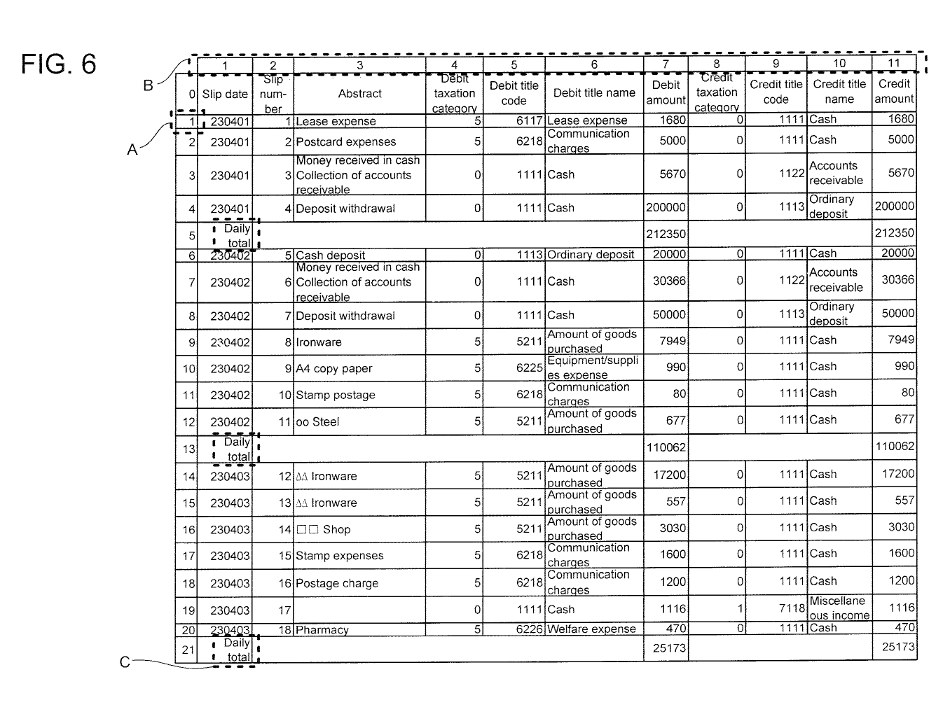

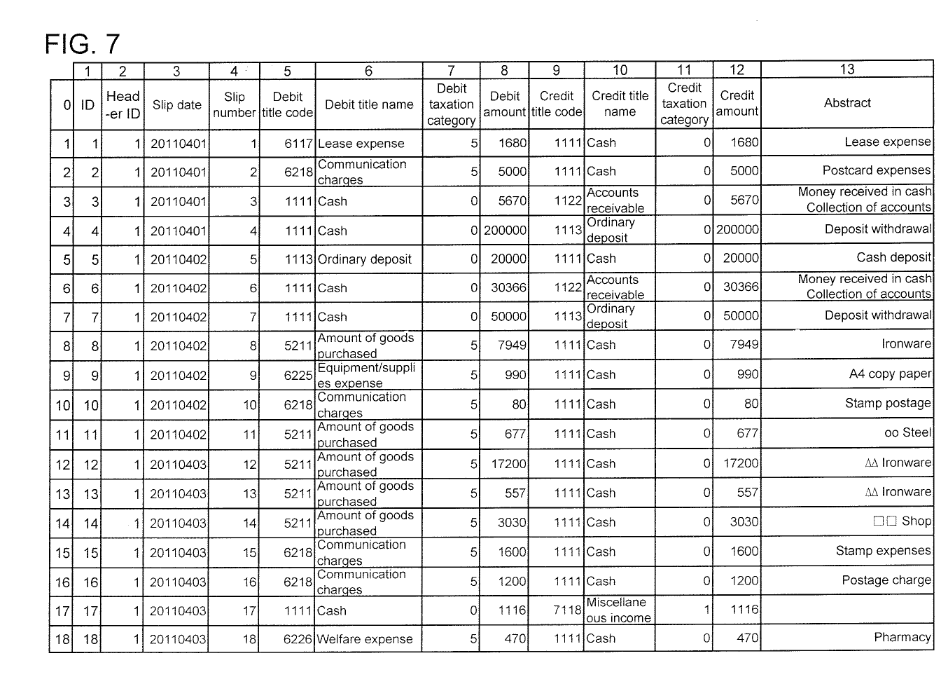

Referring again to FIG. 2, step S2 will be described with reference to FIG. 4, FIG. 6, and FIG. 7. Step S2 is a related-party data placement structure search step, and is executed by the file data placement standardization unit 5.

As described above, the file data placement standardization unit 5 reads out the data placement structure “a” that accords with the read-out related-party accounting journalization file 17 from the file data placement information database 13, and makes a search for the related-party accounting journalization file 17 in accordance with information about the data placement structure “a”. FIG. 3 shows an example of the related-party accounting journalization file 17 read out from the file database 11, and FIG. 6 shows an example of the related-party standardization file 18 that is generated by the file data placement standardization unit 5. Additionally, information about the data placement structure “a” about software by which the related-party accounting journalization file 17 is created is shown with reference to FIG. 4.

In FIG. 6, row numbers and column numbers are assigned in order to clarify the data placement structure of the related-party accounting journalization file 17. At the 0th row, data items (slip date, slip number, abstract, etc.) shown in each column are specified, and this schematically shows a state in which the data item and the data position are recognizably combined together by adding information about row numbers and column numbers in the related-party standardization file 18 generated at step S3.

A search for the related-party data placement structure has three steps, more specifically, the read-in start row search step of step S2-1, the read-in column search step of step S2-2, and the read-in needless row search step of step S2-3.

Step S2-1 is a step of making a search for a read-in start row based on the data placement structure “a” in the enumerating data of the related-party accounting journalization file 17. This related-party accounting journalization file 17 is created with reference to the data placement structure “a,” and therefore, the data start row is the first one as shown in FIG. 4, and a search for the first row is made in order to start read-in from the data position at the first row (see sign (A) in FIG. 6).

Step S2-2 is a step of making a search for a read-in column based on the data placement structure “a” in the enumerating data of the related-party accounting journalization file 17. Concerning the read-in column, information about column which which data about journalization presents is input, that is, data items (slip date, slip number, and abstract) and data positions (1st column, 2nd column, and 3rd column) are input as shown in an example of FIG. 4 in which the slip date is in the first column, the slip number is in the second column, and the abstract is in the third column, and therefore, a search for each read-in column is made with respect to each data item (see sign (B) in FIG. 6). As a matter of course, in addition to these examples, there are many other examples about data items and data positions as shown in FIG. 5.

Step S2-3 is a step of making a search for a read-in needless row based on the data placement structure “a” in the enumerating data of the related-party accounting journalization file 17. As shown in FIG. 4, the value of the first column is “Except” exclusive of “Daily total” as the designation of read-in record, and therefore, the read-in needless row is a row where the letters of “daily total” are present in the first column. Therefore, at this step, from the enumerating data, a search is made regarding the row of “Daily total” as a read-in needless row (see sign (C) in FIG. 6). The order from step S2-1 to step 2-3 is negligible, and any one of the three steps may be first executed, or the three steps may be executed simultaneously.

Step S3 of FIG. 2 is a file data placement standardization step. This step is also executed by the file data placement standardization unit 5. At this step, individual pieces of data of the enumerating data included in the related-party accounting journalization file 17 and the data placement structure “a” (information about data items and data positions) are linked together, and, as a result, data is generated as the related-party standardization file 18 in which the position of the enumerating data of the related-party accounting journalization file 17 and the kind of the data present at that position are recognizable. In other words, as shown in FIG. 6, information about row numbers and column numbers is added as the data placement structure “a,” and data items and data positions are linked together to be recognized, and, as a result, a related-party standardization file 18 is generated.

Thereafter, the file data placement standardization unit 5 readably stores this related-party standardization file 18 in the standardization file database 12.

Additionally, at step S3, the standard data placement structure 20 may be read out from the file data placement information database 13, and individual pieces of data of the enumerating data included in the related-party accounting journalization file 17 and the standard data placement structure 20 (information about data items and data positions) may be linked together, and the pieces of enumerating data of the related-party accounting journalization file 17 may be rearranged according to the standard data placement structure 20, and, as a result, data may be generated as a related-party standardization file 18 to be recognizable. Likewise, here, data generated through the file read-in setting unit 3 may be read out, or data prepared in the file data placement standardization unit 5 may be read out without being limited to the fact that the standard data placement structure 20 reads out data from the file data placement information database 13.

A data placement structure shown in FIG. 7 is mentioned as a specific example of the related-party standardization file 18 in which pieces of enumerating data have been rearranged. This shows schematically a state in which the file data placement standardization unit 5 has rearranged pieces of enumerating data included in the related-party accounting journalization file 17 along the standard data placement structure 20. With regard to the movement in the columns, “Abstract” placed in the third column in FIG. 6 is moved to the 13th column in FIG. 7, and, likewise, “Slip date” is moved from the first column to the third column, “Slip number” is moved from the second column to the fourth column, “Debit amount” is moved to the eighth column from the seventh column, and “Credit amount” is moved from the 11th column to the 12th column although common points between FIG. 6 and FIG. 7 are the fact that information about row numbers and column numbers is added and the fact that data items are placed at the first row in comparison with the data placement structure of the related-party accounting journalization file 17 shown in FIG. 6.

After the second row to the subsequent rows, slips are enumerated in order of earliness in slip date along its slip numbers.

Debit title codes in the fifth column and credit title codes in the ninth column are respectively codes employed directly by software by which the related-party accounting journalization file 17 is created, and these are not changed when a rearrangement is made from FIG. 6 to FIG. 7. Additionally, “ID” in the first column and “Header ID” in the second column of FIG. 7 are IDs appropriately given by the system or by a system provider, and “ID” is given in each journal slip.

The debit taxation category in the seventh column and the credit taxation category in the 11th column are taxation categories that are required for return for consumption tax, and, more specifically, are categories to classify the imposition, exemption, non-taxation, and the like of consumption tax.

The data placement structures are unified by making the rearrangement of data along the standard data placement structure 20 in this way regardless of the data placement structures “a” to “n” of the related-party accounting journalization file 17, and therefore, it is recommended to treat commonly-placed data in subsequent data processing, and, as a result, processing efficiency can be heightened by uniform processing, and the possibility that the frequency of improper processing will be reduced is high, and the accuracy of data processing can be improved. Additionally, a user can more easily process a uniform data structure than a non-uniform data structure when the contents of data are required to be checked, and treatability also becomes easy.

As a matter of course, if the relationship between data items and data positions is understandable, processing can be performed at step S4 and at the subsequent steps without rearranging data in conformity with the standard data placement structure 20.

Next, step S4 of FIG. 2 will be described. Step S4 is a debit credit title extraction step, and is executed by the related-party title search unit 7 of the title matching processing unit 6 shown in FIG. 1. The related-party title search unit 7 reads out the related-party standardization file 18 stored in the standardization file database 12, and extracts debit title names and credit title names from thereamong. In the related-party standardization file 18, the relationship between a data item and a data position is understood in not only a case in which pieces of data are rearranged along the standard data placement structure 20 but also a case those are not rearranged, and therefore, debit title names and credit title names can be easily extracted from the related-party standardization file 18.

The related-party standardization file 18 may be received directly from the file data placement standardization unit 5, and then step S4 may be executed although the related-party title search unit 7 may read out the related-party standardization file 18 from the standardization file database 12.

Step S5 is a related-party title search step, and is a step likewise executed by the related-party title search unit 7 subsequently to step S4.

At this step, it is retrieved whether a debit title name and a credit title name extracted at step S4 have already been registered as the linkage title data 22 stored in the related-party title information database 15.

Although the linkage title has already been described with reference to FIG. 8 in describing the related-party title information database 15, the linkage title is a title in the related-party standardization file 18 that has already been linked with the standard title ID of the standard title included in the standard title data 21 in the related-party standardization file 18. The related-party standardization file 18 is created based on the related-party accounting journalization file 17, and this related-party accounting journalization file 17 is created based on journal slips created every day, and therefore, this related-party accounting journalization file 17 is generated or updated every day.

Therefore, when the related-party accounting journalization file 17 of a new related party is read in, there is no linkage title, and all titles undergo linkage processing with standard titles, and, as a result, linkage titles are generated, and yet the number of titles that have already undergone linkage processing is increased with the lapse of time, and the number of times of linkage processing is reduced.

At step S5, the related-party title search unit 7 reads out and retrieves the linkage title data 22 stored in the related-party title information database 15 while using the debit title name and/or the credit title name extracted from the related-party standardization file 18 as a key, and, if the debit title name and/or the credit title name has been detected, a search is made directly for the following title.

These steps S4 and S5 are steps executed by the related-party title search unit 7, and the effect obtained by executing these steps has already been described as the effect obtained by having the related-party title search unit 7 and the related-party title information database 15.

If the related-party title search unit 7 did not detect the debit title name and/or the credit title name in spite of a search for the linkage title data 22 stored in the related-party title information database 15, the process proceeds to the following step S6.

Step S6 is a standard title search step. This step is executed by the standard title search unit 8. The standard title search unit 8 reads out and retrieves the matched title data 23 stored in the matched title information database 16 while using the debit title name and/or the credit title name included in the related-party standardization file 18, which was not detected in spit of a search for the linkage title data 22 at step S5, as a key.

As already described above, the matched title denotes an aggregate of linkage titles in which standard title IDs are linked to debit title names and/or credit title names collected from all related parties, and a schematic view of its data structure is shown at the lower part of FIG. 9, and this is read out and is retrieved from the matched title information database 16.

If the debit title name or the credit title name is detected by a search, the standard title ID correlated in the matched title data 23 is linked, and is readably stored in the related-party title information database 15 of the related party as the linkage title data 22. Alternatively, it is readably stored in the matched title information database 16 as the matched title data 23.

As described above, the title matching processing unit 6 links the standard title ID to the debit title name and/or the credit title name included in the related-party standardization file 18 in this way.

Thereafter, the following title that was not detected is retrieved.

This step S6 is a step executed by the standard title search unit 8, and the effect obtained by executing this step has already been described as the effect obtained by having the standard title search unit 8 and the matched title information database 16.

On the other hand, if the debit title name or the credit title name is not detected, the process proceeds to the following step S7.

Step S7 is an extraction title linkage processing step. This step is executed by the extraction title linkage processing unit 9. If the matched title data 23 was not detected by the standard title search unit 8 at step S6 in spite of a search for the matched title data 23, the extraction title linkage processing unit 9 receives the input of the desirably correlated standard title data 21 from the standard title information database 14, and links the standard title ID thereto so as to serve as a matched title, and readably stores it in the matched title information database 16. Alternatively, the extraction title linkage processing unit 9 may receive the input of the standard title data 21 from the input unit 2, and may link the standard title ID to the debit title name and/or the credit title name that was not retrieved in the matched title data 23, and may readably store it in the matched title information database 16 as a matched title. Alternatively, it may be readably stored in the related-party title information database 15 as a linkage title of its related party.

The input of the standard title ID in the extraction title linkage processing unit 9 has been described as in FIG. 10 referring to which the extraction title linkage processing unit 9 has already been described. Additionally, one example of the data structure of the standard title data 21 is shown in the table of the upper part of FIG. 9 as already described.

Step S7 is a step executed by the extraction title linkage processing unit 9, and the effect obtained by executing this step has already been described as the effect obtained by having the extraction title linkage processing unit 9 and the standard title information database 14.

As described above, step S1 to step S7 are executed, and, as a result, all of the account title names (debit title names and credit title names) included in the related-party standardization file 18 are linked to the standard title IDs. More specifically, the linkage title data 22 of each related party is readably stored in the related-party title information database 15. Moreover, when a debit title name or a credit title name, which is a first title name at the present related party, and which is not included in the linkage title data 22, and which has already been included at another related party as the matched title data 23, is discovered, the title of the present related party is given the standard title ID of the matched title so as to be a linkage title, and is readably stored in the related-party title information database 15.

The title matching processing unit 6 links the standard title ID to the debit title name and/or the credit title name included in the related-party standardization file 18 on the standard title data 21 or on the matched title data 23 in this way.

Although step S4 to step S7 are executed by the title matching processing unit 6, these steps may be selectively executed. If so, as described above, it is recommended to receive the related-party standardization file 18 directly from the file data placement standardization unit 5 at the time of execution of step S4 and then perform retrieval or processing. Additionally, it is recommended to store the related-party standardization file 18 in the standardization file database 12 after completion of each step.

### Embodiment 2

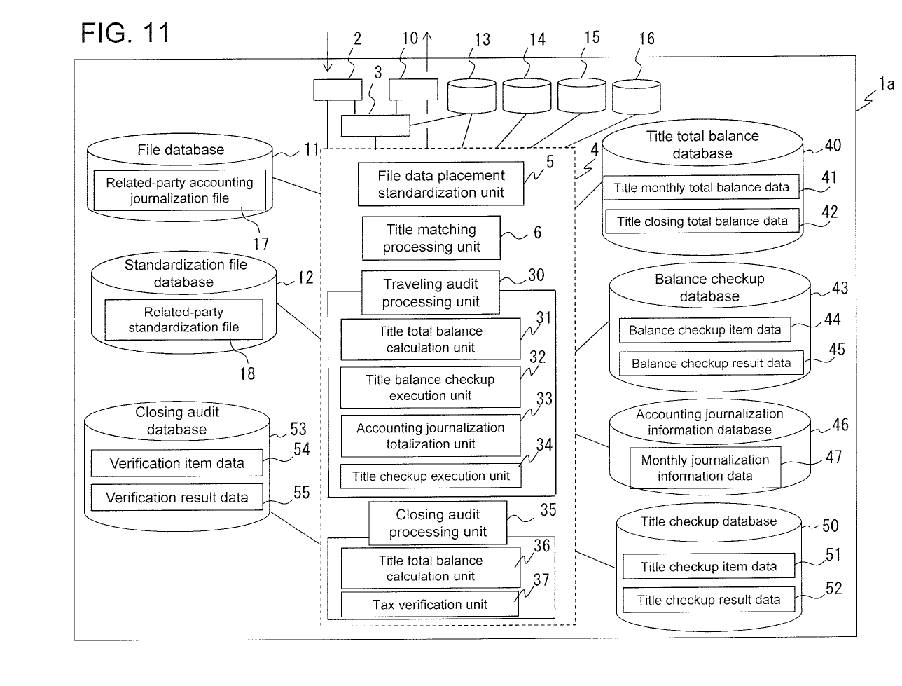

An audit system according to Embodiment 2 (hereinafter referred to as “the second embodiment”) of the present invention will be hereinafter described with reference to FIG. 11 to FIG. 20. (Corresponding to the invention described in claims 7 to 12, in particular.)

FIG. 11 is a conceptual diagram of the audit system according to the second embodiment of the present invention.

In FIG. 11, the audit system 1a has an arrangement of the accounting journalization file data standardization system 1 described as the first embodiment, and the arithmetic unit 4 is additionally provided with a traveling audit processing unit 30 and a closing audit processing unit 35, and, as a database group, the following databases are additionally provided, that is, a title total balance database 40, a balance checkup database 43, an accounting journalization information database 46, a title checkup database 50, and a closing audit database 53 are provided. An arrangement included in the accounting journalization file data standardization system 1 has already been described in the first embodiment, and therefore, a description of this arrangement is omitted in the second embodiment.

First, the traveling audit processing unit 30 added to the arithmetic unit 4 will be described.

The traveling audit processing unit 30 is composed of a title total balance calculation unit 31, a title balance checkup execution unit 32, an accounting journalization totalization unit 33, and a title checkup execution unit 34. This is to check whether the total balance and the contents of journalization itself are correct for each account title (debit title and credit title) with respect to slip journalization by using the related-party standardization file 18 generated by the file data placement standardization unit 5 according to the first embodiment.

The title total balance calculation unit 31 reads out the related-party standardization file 18 from the standardization file database 12, and calculates the title total balance of each debit title and that of each credit title included in this. Generally, the calculation period (storage period of data used for calculation) is often set as each month (monthly) although it depends on a request from a related party or the like, and therefore, in the present embodiment, the title total balance calculation unit 31 generates title monthly total balance data 41 monthly, and stores it in the title total balance database 40. As a matter of course, the calculation period can be desirably changed to “weekly” or “daily” by, for example, a request from a related party.

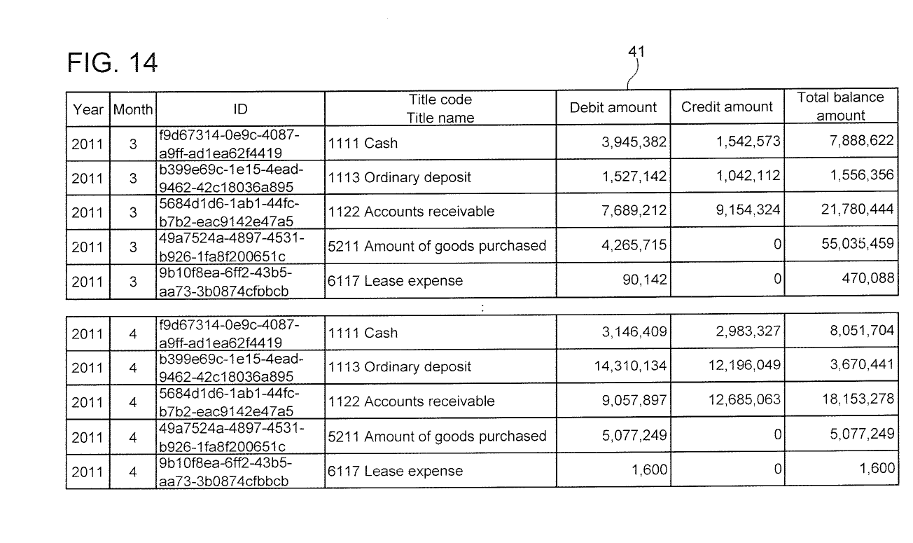

FIG. 14 shows an example of the title monthly total balance data 41 including a title total balance calculated for each account title. Year, month, ID, title code title name, debit amount, credit amount, and total balance amount are shown in order from the left column. The total balance of each account title, such as cash, ordinary deposit, or accounts receivable, is calculated monthly in order from the upper row.

Herein, the ID and the title code title name are inherent in a related party, and neither the standard title nor the standard title ID is included. The reason is that the title total balance can be calculated by using the ID or the title code title name of the related party.

In other words, it is not necessary to search for the linkage title data 22 and the matched title data 23 until the title total balance is calculated by the title total balance calculation unit 31. Therefore, although the title total balance calculation unit 31 is included in the traveling audit processing unit 30 in the present embodiment, this function may be provided to the file data placement standardization unit 5 of the accounting journalization file data standardization system 1 according to the first embodiment. If so, the title monthly total balance data 41 will be included in the related-party standardization file 18. Additionally, if the file data placement standardization unit 5 is allowed to have the function of the title total balance calculation unit 31, the title total balance calculation unit 31 will be equivalent to the file data placement standardization unit 5.

Next, the title balance checkup execution unit 32 of the traveling audit processing unit 30 will be described. The title balance checkup execution unit 32 is a component that checks for the title monthly total balance data 41 calculated by the title total balance calculation unit 31. Items to be checked are desirably predetermined, and are readably stored in the balance checkup database 43 as balance checkup item data 44.

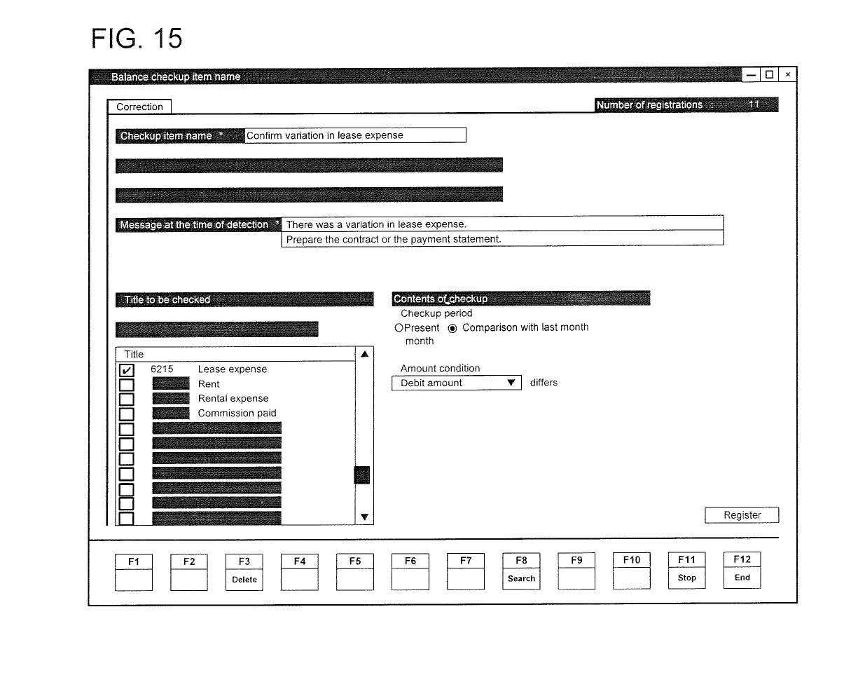

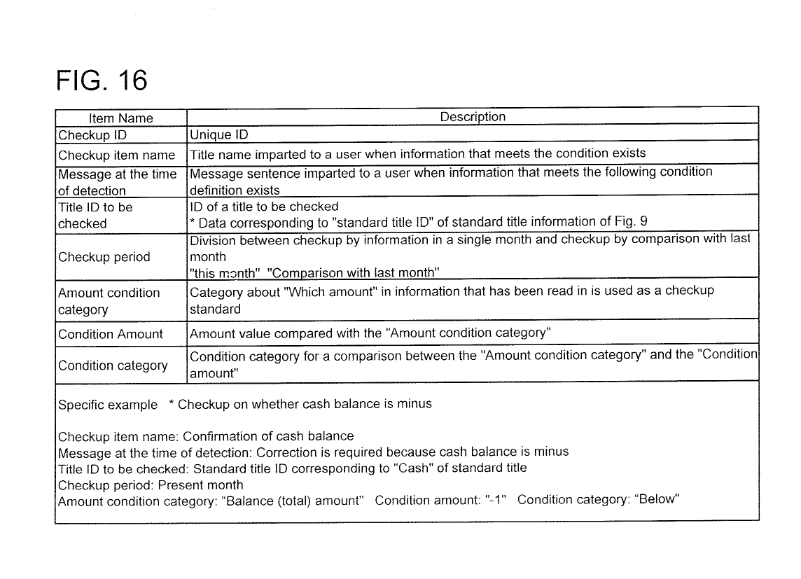

Here, the balance checkup item will be described with reference to FIG. 15 and FIG. 16. FIG. 15 is a conceptual diagram showing one example of a data input screen (interface screen) when the balance checkup item data 44 is generated. FIG. 16 is a list specifically showing the contents of items included in the balance checkup item data 44.

The balance checkup item data 44 may be generated by the title balance checkup execution unit 32 and then be readably stored in the balance checkup database 43, or may be provided as an exclusive generation unit in the traveling audit processing unit 30 or in the arithmetic unit 4.

With respect to “Lease expense” of title code 6215 shown as an example in FIG. 15, a message saying “There was a variation in lease expense” that is a message at the time of detection displayed through the output unit 10 when debit amounts are different in the collation of last month's title total balance with this month's title total balance. Additionally, a message saying “Please prepare a contract or a payment statement” is displayed at the time of detection through the output unit 10, and an action to be afterwards taken by the user of the system is presented, and, as a result, it becomes possible to facilitate the auditing service.

“Lease expense” of the title of title code 6215 is a standard title code and a standard title name, which is mentioned as an important point. In other words, the balance checkup item is a checkup item corresponding to the standard title (code). Therefore, when this balance checkup item is collated with the total balance of each debit title and that of each credit title of the related party, the standard title ID of the linkage title is detected from the title ID corresponding to the debit title and the credit title of the related party, and a search is made for the balance checkup item of the standard title corresponding to the standard title ID so as to be correlated with the title total balance of the related party mentioned above.

Therefore, even if it is a title total balance concerning an account title name depending on different specifications of different related parties, it is possible to apply a balance checkup item common to all, and it is possible to perform a monthly title balance checkup that is efficient and uniform and highly accurate.

The reason why the amount condition is a debit amount is that the debit amount is an amount billed from a leasing contractor with respect to the lease expense of the debit title, whereas the credit amount is an amount to be paid by the related party, for example, cash, and therefore, a variation in this debit amount is nothing less than the fact that a variation in the lease expense or the like has occurred as shown in the message shown at the time of detection.

Although one example is shown in FIG. 15, specific items stored as the balance checkup item data 44 are described in FIG. 16 in addition to the example of FIG. 15.

In FIG. 16, in the left column, “Checkup ID,” “Checkup item name,” “message at the time of detection,” etc., are listed as item names. In the right column, a description of each item is entered.

Among these item names, “Checkup ID” is an ID given uniquely to each balance checkup item, and can be equated with the balance checkup item, and the title balance checkup execution unit 32 executes a balance checkup by using this checkup ID. “Checkup item name” is a title name imparted to an user when an item meeting with a condition is present as entered in the description column. Likewise, with respect to “message at the time of detection,” a sentence entered in the lower column is stored.

Specific examples are entered in the lower column. A balance checkup item is provided for the presence or absence of a title having a minus balance. In an amount condition category, “Balance (total) amount” “Below” “−1” yen is detected. At this time, the message at the time of detection is also expressed as “There is a title having a minus balance” to call user's attention. “FIG. 9” in the description of “title ID to be checked” denotes FIG. 9 of the second embodiments of the present invention.

The title balance checkup execution unit 32 reads out this balance checkup item data 44 from the balance checkup database 43, and reads out the title monthly total balance data 41 calculated by the title total balance calculation unit 31 from the title total balance database 40, or, alternatively, receives it directly from the title total balance calculation unit 31, and collates the title total balance of each debit title and that of each credit title with the balance checkup item data 44.

In more detail about processing performed at this time, when the title balance checkup execution unit 32 collates the balance checkup item with the total balance of each debit title and that of each credit title of a related party, the linkage title data 22 is retrieved by accessing the related-party title information database 15, and, as a result, the standard title ID of the linkage title is detected from the title ID corresponding to the debit title name and the credit title name of the related party, and thereafter the balance checkup item of the standard title corresponding to this standard title ID is retrieved, and is correlated with the title total balance of the aforementioned related party. In other words, the standard title ID is retrieved from the linkage title data 22, and the balance checkup item is retrieved from the standard title ID for each title ID corresponding to the debit title name and the credit title name of the related party, and the title total balance of each debit title name and that of each credit title name of the related party are collated therewith.

This processing makes it possible to correlate the balance checkup item common to each account title of a plurality of related parties. Additionally, even if items that can be collected into a single account title in tax/account procedures are individually journalized because of, for example, a lack of specialized knowledge of a related party, a checkup can be simultaneously performed by using a balance checkup item about a common standard title, and therefore, in this respect, an efficient and leak-free audit can be performed.

The title balance checkup execution unit 32 extracts at least the checkup item ID of a balance checkup item correlated by collation and the related-party title ID corresponding to a debit title name or a credit title name of a related party, and readably stores these in the balance checkup database 43 as balance checkup result data 45.

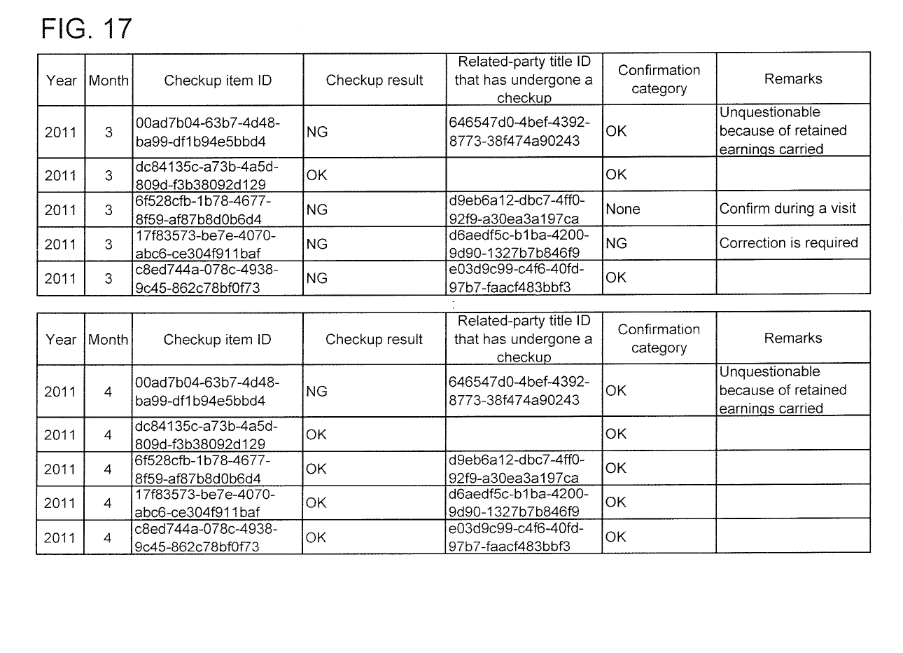

FIG. 17 is a list showing specific examples of the contents of data included in the balance checkup result data 45. In FIG. 17, balance checkup results in March 2011 and in April 2011 are shown. Either OK or NG as a checkup result is entered for each checkup item ID, and the title ID of a related party relative to its checkup is also entered. With respect to the confirmation category, None, which is used when the possibility that the result will be neither NG nor OK or that the result will be NG or OK depends on a related party, is entered in addition to OK and NG. This confirmation category and remarks can be freely entered by a user, and it is recommended to allow the user to appropriately input it through the input unit 2 while allowing the title balance checkup execution unit 32 to display an input screen (not shown) urging the user to input data through the output unit 10, and it is recommended to thereafter store the data in the balance checkup database 43 as balance checkup result data 45.

In the present embodiment, although it is impossible to understand directly from this data about the specific contents of checkup items and about which one of the account titles was checked because the result is shown by both the checkup item ID and the related-party title ID, the title balance checkup execution unit 32 can display the contents of checkup items and the contents of account titles by searching for the linkage title data 22, the matched title data 23, and the balance checkup item data 44. Therefore, it is possible to equate the checkup item ID and the balance checkup item with each other and equate the related-party title ID and the debit and credit title names of the related party with each other here.

Next, the accounting journalization totalization unit 33 of the traveling audit processing unit 30 will be described. The accounting journalization totalization unit 33 is to generate accounting journalization information by totalizing accounting journalization included in the related-party standardization file 18 during a desirably determined period. Likewise, in this case, the calculation period (storage period of data used for calculation) depends on a request from a related party or the like, and, generally speaking, is often set as each month (monthly), and therefore, the accounting journalization totalization unit 33 generates monthly journalization information data 47 monthly, and stores it in the accounting journalization information database 46 in the same way as the title total balance calculation unit 31 mentioned above. As a matter of course, the calculation period can be desirably changed to “weekly” or “daily” by, for example, a request from a related party.

The function in the accounting journalization totalization unit 33 may be provided to the file data placement standardization unit 5 of the accounting journalization file data standardization system 1 in the same way as the title total balance calculation unit 31, and, if so, the monthly journalization information data 47 will be included in the related-party standardization file 18.

Thereafter, the title checkup execution unit 34 reads out the monthly journalization information data 47 from the accounting journalization information database 46, or, alternatively, receives the monthly journalization information data 47 directly from the accounting journalization totalization unit 33 and executes the contents of the accounting journalization included therein for each account title. In this case, items to be checked are desirably predetermined, and are readably stored in the title checkup database 50 as title checkup item data 51. If the monthly journalization information data 47 is read out directly from the accounting journalization totalization unit 33, the accounting journalization information database 46 is not required to be provided.

If the file data placement standardization unit 5 has the function of the accounting journalization totalization unit 33, the monthly journalization information data 47 will be included in the related-party standardization file 18, and therefore, the title checkup execution unit 34 reads out the monthly journalization information data 47 from the file data placement standardization unit 5, or, alternatively, reads out the monthly journalization information data 47 stored in the standardization file database 12. In this case, the accounting journalization totalization unit 33 is equivalent to the file data placement standardization unit 5.

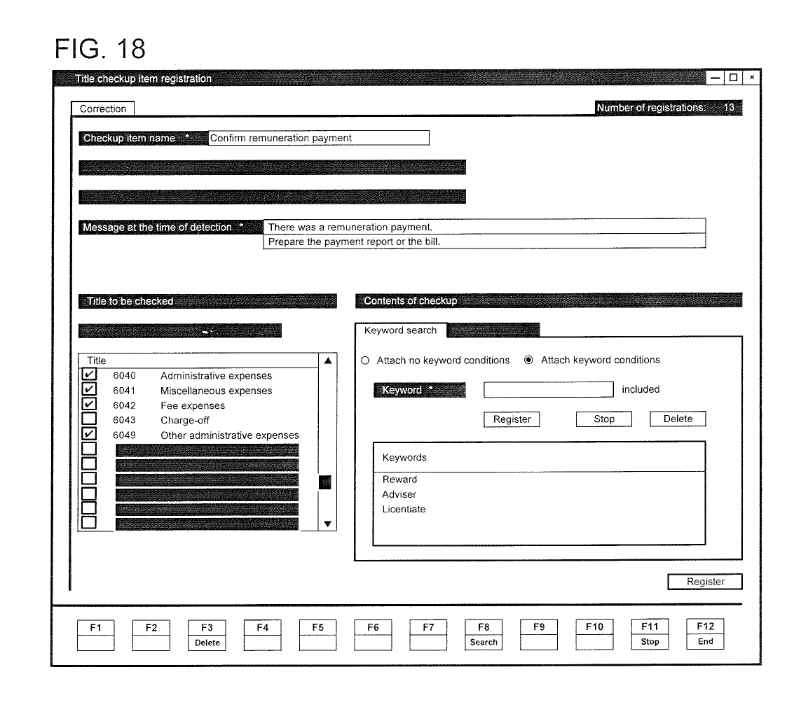

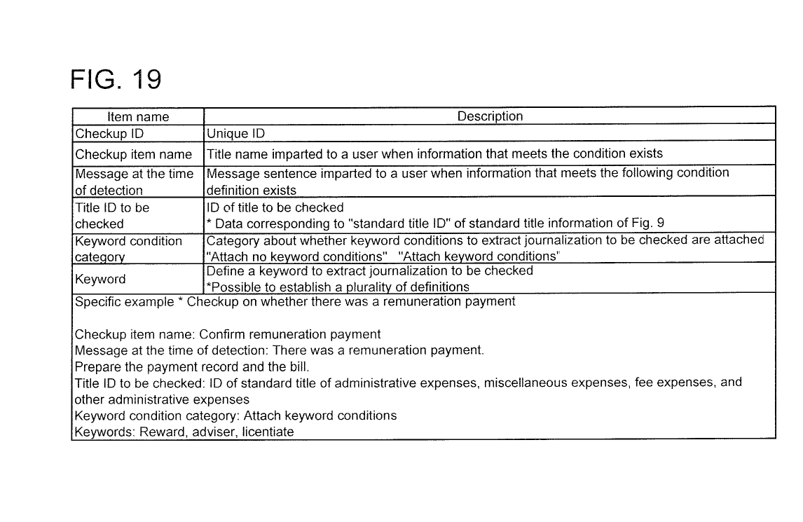

Here, a title checkup item will be described with reference to FIG. 18 and FIG. 19. FIG. 18 is a conceptual diagram showing one example of a data input screen (interface screen) when the title checkup item data 51 is generated. FIG. 19 is a list specifically showing the contents of items included in the title checkup item data.

The title checkup item data 51 may be generated by the title checkup execution unit 34 and be readably stored in the title checkup database 50, or may be provided as an exclusive generation unit in the traveling audit processing unit 30 or in the arithmetic unit 4.

In FIG. 18, the checkup item name is entered as “Remuneration payment confirmation,” and “Administrative expenses” of title code 6040, “Miscellaneous expenses” of title code 6041, “Fee expenses” of title code 6042, and “Other administrative expenses” of title code 6049 are shown as examples. Data including “Reward,” “Adviser,” and “Licentiate” used as keywords about the contents of journalization (entry of abstract) are designated for a search. Accounting journalization information is collated with these title checkup items, and, if these keywords are detected in the contents of journalization, the message at the time of detection “There was a remuneration payment” is displayed through the output unit 10. Additionally, “Please prepare a payment record and a bill” that is another message at the time of detection is displayed through the output unit 10, and an action to be afterwards taken by a user of the system is presented, and, as a result, it becomes possible to facilitate the auditing service. The reason why “Licentiate” is included in the keywords is that there is a chance to pay a reward to persons having so-called professions, such as lawyers, licensed tax accountants, and patent attorneys.

For example, title code 6040 and administrative expenses of the title name are a standard title code and a standard title name, respectively, in the title checkup item data 51 like the title code and the title name in the balance checkup item data 44. In other words, the title checkup item is also a checkup item corresponding to a standard title (code). Therefore, when this title checkup item is collated with accounting journalization information of each debit title and that of each credit title of a related party, the title checkup execution unit 34 detects the standard title ID of the linkage title from the title ID corresponding to the debit title and the credit title of the related party in the same way as the title balance checkup execution unit 32, and thereafter the balance checkup item of the standard title corresponding to this standard title ID is retrieved, and is correlated with the accounting journalization information of the aforementioned related party.

Therefore, even if it is accounting journalization information about an account title name depending on different specifications of different related parties, it is possible to apply a title checkup item common to all, and it is possible to perform a monthly title checkup that is efficient uniform and highly accurate.

One example is shown in FIG. 18, and specific items stored as the title checkup item data 51 are various in addition to this example, and can be desirably and specifically determined by a user as shown in FIG. 19.

In FIG. 19, in the left column, “Checkup ID,” “Checkup item name,” “message at the time of detection,” etc., are listed as item names. In the right column, a description of each item is entered.

Among these item names, “Checkup ID” is an ID given uniquely for each title checkup item, and can be equated with the title checkup item, and the title checkup execution unit 34 executes a title checkup by using this checkup ID. “Checkup item name” is a title name imparted to the user when an item meeting with a condition is present in the same way as the balance title checkup item of FIG. 16. Likewise, with respect to “message at the time of detection,” a sentence entered in the lower column of this figure is stored.

Specific examples are entered in the lower column, showing the case of the remuneration payment confirmation described with reference to FIG. 18. “FIG. 9” in the description of “To-be-checked title ID” denotes FIG. 9 of the present embodiment.

The title checkup execution unit 34 reads out the title checkup item data 51 from the title checkup database 50, and reads out the monthly journalization information data 47 totalized by the accounting journalization totalization unit 33 from the accounting journalization information database 46, or, alternatively, receives it directly from the accounting journalization totalization unit 33, and collates journalization information about each journalization (each slip) with the title checkup item data 51.

In more detail about processing performed at this time, “To-be-checked title ID” is included in the title checkup item data 51 as shown in FIG. 19, and this corresponds to the standard title ID. Therefore, the process uses the standard title ID through which the title checkup item is collated with the monthly journalization information data 47 so as to determine its presence or absence.

Therefore, when the title checkup execution unit 34 collates the title checkup item with the accounting journalization information of a related party, the linkage title data 22 is retrieved by accessing the related-party title information database 15, and, as a result, the standard title ID of the linkage title is detected from the title ID corresponding to the debit title name and the credit title name of the related party that is included in the monthly journalization information data 47, and thereafter the title checkup item concerning the standard title corresponding to this standard title ID is retrieved, and is correlated with monthly accounting journalization information. This processing makes it possible to correlate the title checkup item common to each account title of a plurality of related parties. Additionally, even if items that can be collected into a single account title in tax/account procedures are individually journalized because of, for example, a lack of specialized knowledge of a related party, a checkup can be simultaneously performed by using a title checkup item about a common standard title, and therefore, in this respect, an efficient and leak-free audit can be performed in the same way as the title balance checkup mentioned above.

The title checkup execution unit 34 extracts at least the checkup item ID of the title checkup item correlated by collation and the accounting journalization information, and readably stores these in the title checkup database 50 as title checkup result data 52.

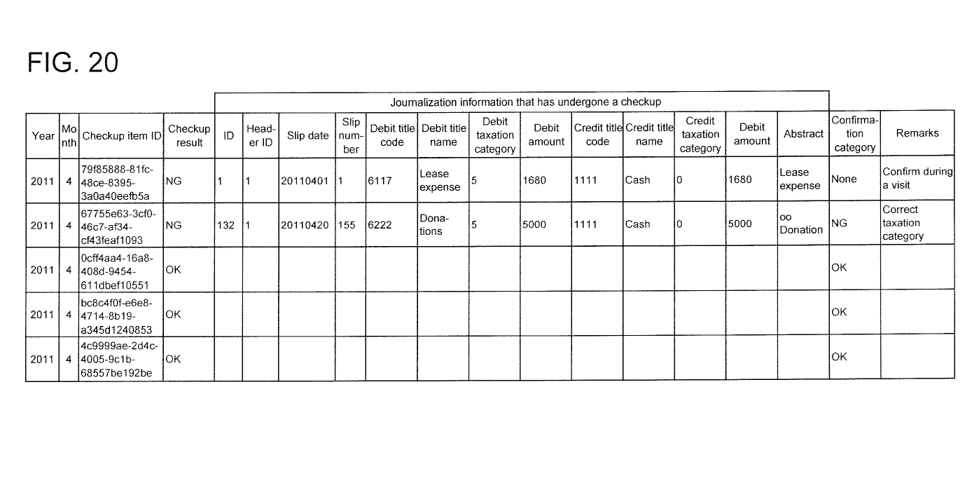

FIG. 20 is a list showing specific examples of the contents of data included in the title checkup result data 52. In FIG. 20, title checkup results in April 2011 are shown in the form of either NG or OK. The checkup item ID is shown in the same way as the balance checkup result data 45, and accounting journalization information that has undergone a checkup is included therein. The contents of the related-party standardization file 18 described with reference to FIG. 7 are shown in this accounting journalization information. As in FIG. 7 schematically showing a state in which the file data placement standardization unit 5 has rearranged pieces of enumerating data included in the related-party accounting journalization file 17 along the standard data placement structure 20, the journalization information has the data structure, and yet may has a placement structure shown in, for example, FIG. 6 without rearrangement, as a matter of course.

With respect to the data structure of the title checkup result data 52, “ID” and “Header ID” are described in the same way as in FIG. 7. In FIG. 19, with respect to NG in the accounting journalization information when ID=1, according to the remarks column, a confirmation is received from a related party during a visit, and this shows that the title checkup execution unit 34 shows this title checkup result to a user through the output unit 10, and, in the processing responding to this, the user inputs it through the input unit 2 as remarks. With respect to NG in the accounting journalization information when ID=132, this is displayed, for example, when the taxation category of a consumption tax on a donation paid in cash is corrected, and a description to this effect is given in the remarks column.

The remarks can be freely entered by the user in the same way as the balance checkup result data 45 shown in FIG. 17, and the user is allowed to appropriately input it through the input unit 2 while allowing the title checkup execution unit 34 to display an input screen (not shown) urging the user to input data through the output unit 10, and thereafter the data is stored in the title checkup database 50 as title checkup result data 52. The same applies to the column of the confirmation category.

In the title checkup execution unit 34, accounting journalization information is checked per journalization unit (slip unit) unlike the title balance checkup execution unit 32, and the contents of the checkup item correspond to the account title (debit title and credit title) as described in FIG. 19, and therefore, there is a need to link the title ID of each related party included in the monthly journalization information data 47 and the checkup item corresponding to each standard title included in the title checkup item together by means of the standard title ID, and, as a result, the aforementioned excellent effect is fulfilled.

Next, the closing audit processing unit 35 will be described. The closing audit processing unit 35 is composed of the title total balance calculation unit 36 and the tax verification unit 37. The title total balance calculation unit 36 reads out the title monthly total balance data 41 from the title total balance database 40, then calculates the title total balance at the closing of accounts, then generates the title closing total balance data 42, and stores it in the title total balance database 40.

Although the title total balance calculation unit 36 is included in the closing audit processing unit 35 in the present embodiment, the title total balance calculation unit 31 of the traveling audit processing unit 30 may be used instead of the title total balance calculation unit 36. Additionally, this function may be provided for the file data placement standardization unit 5 of the accounting journalization file data standardization system 1 according to the first embodiment. If so, the title closing total balance data 42 will be included in the related-party standardization file 18. Additionally, if the function of the title total balance calculation unit 36 is provided for the file data placement standardization unit 5, the title total balance calculation unit 36 will be equivalent to the file data placement standardization unit 5.

The tax verification unit 37 reads out the title closing total balance data 42 and the title monthly total balance data 41 from the title total balance database 40, or, alternatively, receives these directly from the title total balance calculation unit 36, and reads out the monthly journalization information data 47 from the accounting journalization information database 46 or receives it directly from the accounting journalization totalization unit 33, and verification about the closing audit is executed.

With respect to items to be verified, verification items desirably predetermined from the closing audit database 53 are readably stored in the closing audit database 53 as verification item data 54. The tax verification unit 37 reads out this verification item data 54, then collates this with the title monthly total balance data 41, with the title closing total balance data 42, and with the monthly journalization information data 47, then extracts at least corresponding verification items, and readably stores these in the closing audit database 53 as verification result data 55.

In the thus arranged closing audit processing unit 35, a closing audit is executed based on the processes executed so far in the traveling audit processing unit 30, and an auditing service has already been executed by using the standard title ID in an efficient, uniform, and highly accurate manner, and therefore, this closing audit service can inherit its profits, and it is possible to execute the closing audit in a uniform, highly accurate, and highly efficient manner

In the closing audit, cases in which verification is performed for each debit title or each credit title are few, and therefore, in the processing in the closing audit processing unit 35, a description is omitted of the fact that the standard title ID of the linkage title is detected from the title ID of the debit and credit title names of a related party, and thereafter a verification item about the standard title corresponding to the standard title ID is retrieved, and is collated with the title monthly total balance data 41, with the title closing total balance data 42, and with the monthly journalization information data 47 as in the processing executed by the title balance checkup execution unit 32 or by the title checkup execution unit 34, and, if there is a verification item about a common standard title through a standard title ID, it is preferable to execute the same processing, as a matter of course.

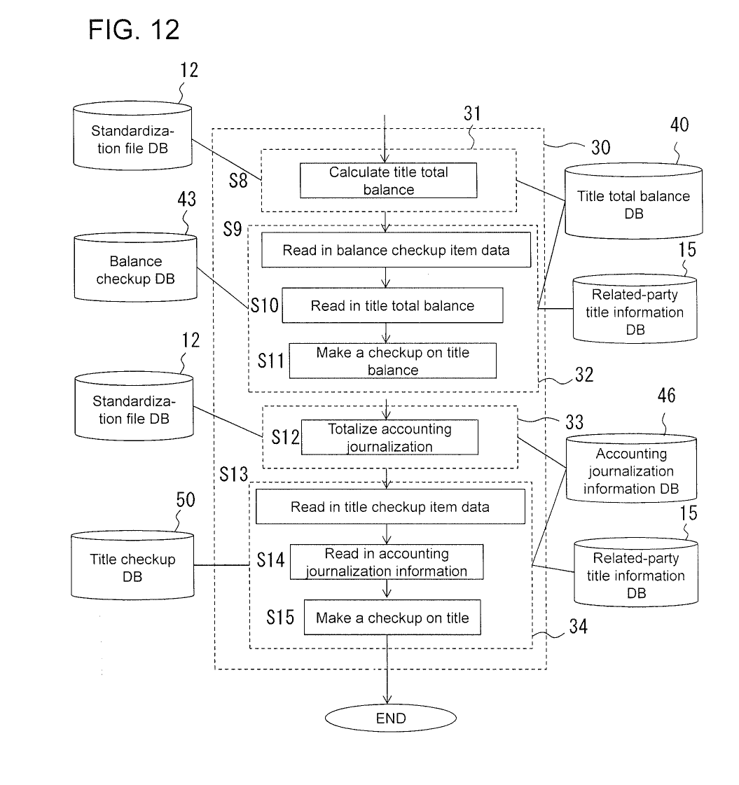

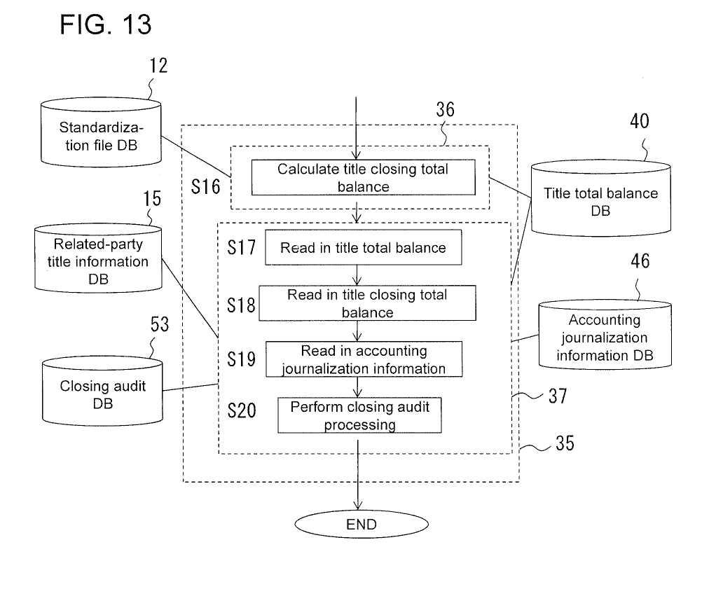

The flow of data processing in the audit system 1a according to the present embodiment will be hereinafter described with reference to FIG. 12 and FIG. 13. FIG. 12 is a flowchart showing the flow of the data processing of a monthly audit in the traveling audit processing unit 30 of the audit system 1a, and FIG. 13 is a flowchart showing the flow of the data processing of a closing audit in the closing audit processing unit 35 of the audit system 1a. With respect to the audit program of the present invention, these figures show its execution steps, and therefore, a description of the flow of data processing in the audit system 1a with reference to these figures is synonymous with a description of an embodiment of the audit program. Additionally, data processing has already been described with reference to FIG. 11, and therefore, an overlapping description of the data processing is omitted.

In FIG. 12, a description starts from step S8 on the assumption that steps are executed continuously from the flow of the data processing shown in FIG. 2.

Step S8 is a title total balance calculation step executed by the title total balance calculation unit 31. At this step, the related-party standardization file 18 stored in the standardization file database 12 is read out, and a calculation is then executed, and the title monthly total balance data 41 is generated, and is readably stored in the title total balance database 40. The contents of this calculation have already been described with reference to FIG. 11.

This step may be executed at the file data placement standardization step that is step S3 described with reference to FIG. 2. If so, the step will be executed by the file data placement standardization unit 5, and the title monthly total balance data 41 will be included in the related-party standardization file 18, and therefore, the title total balance database 40 is not particularly required to be provided, and it is possible to exclude step S8.

Next, step S9 will be described. Step S9 is a balance checkup item file read-in step executed by the title balance checkup execution unit 32. At this step, the title balance checkup execution unit 32 reads out the balance checkup item data 44 stored in the balance checkup database 43. The specific contents of this balance checkup item data 44 have already been described as above.

Step S10 is a title total balance read-in step executed by the title balance checkup execution unit 32 in the same way. At this step, the title balance checkup execution unit 32 reads out the title monthly total balance data 41 from the title total balance database 40. As described above, although it is conceivable that the title total balance database 40 is absent if the title monthly total balance data 41 has already been calculated at step S3, the title monthly total balance data 41 will be read out from the related-party standardization file 18 of the standardization file database 12 if so. The order of step S9 and step 10 is negligible, and either one of the two steps may be first executed, or the two steps may be executed simultaneously.

Thereafter, at step S11, the title balance checkup execution unit 32 executes a title balance checkup step. At this step, the title monthly total balance data 41 is collated with respect to the balance checkup item data 44, and at least the checkup item ID of a balance checkup item correlated by collation and the related-party title ID corresponding to a debit title name or a credit title name of a related party are extracted and are readably stored in the balance checkup database 43 as balance checkup result data 45. The flow of processing about the collation has already been described above with reference to, for example, FIG. 11.

Next, step S12 will be described. Step S12 is an accounting journalization totalization step executed by the accounting journalization totalization unit 33. At this step, the accounting journalization totalization unit 33 reads out the related-party standardization file 18 stored in the standardization file database 12, and thereafter accounting journalization included therein is totalized by a desirably determined period, and, as a result, accounting journalization information is generated and is readably stored in the accounting journalization information database 46 as monthly journalization information data 47.

As described above, the function of the accounting journalization totalization unit 33 at this step S12 can be included in the file data placement standardization unit 5 in the same way as at step S8, and, if so, the monthly journalization information data 47 will be included in the related-party standardization file 18, and therefore, the accounting journalization information database 46 is not particularly required to be provided, and step S12 can also be excluded.

Step S13 is a title checkup item file read-in step executed by the title checkup execution unit 34. At this step, the title checkup execution unit 34 reads out the title checkup item data 51 stored in the title checkup database 50. The specific contents of this title checkup item data 51 have already been described as above.

Step S14 is an accounting journalization information read-in step executed by the title checkup execution unit 34 in the same way. At this step, the title checkup execution unit 34 reads out the monthly journalization information data 47 from the accounting journalization information database 46. Likewise, in this case, although it is conceivable that the accounting journalization information database 46 is absent if the monthly journalization information data 47 has already been calculated at step S3 as described above, the monthly journalization information data 47 will be read out from the related-party standardization file 18 of the standardization file database 12 if so. The order of step S13 and step 14 is negligible, and either one of the two steps may be first executed, or the two steps may be executed simultaneously.

At step S15, the title checkup execution unit 34 executes a title checkup step. At this step, the monthly journalization information data 47 is collated with respect to the title checkup item data 51, and at least the checkup item ID of a correlated title checkup item and the accounting journalization information are extracted, and are readably stored in the title checkup database 50 as title checkup result data 52. The flow of processing about the collation has already been described above with reference to, for example, FIG. 11. The process from step S8 to step S11 and the process from step S12 to step S15 are independent of each other as a large process flow, and therefore, either one may be first executed, or both may be simultaneously executed.

The operation and the effect brought about by the flow of data processing performed during the monthly audit have already been described with reference to FIG. 11 and the other figures, and therefore, a description of these operation and effect is omitted.

Next, the flow of data processing performed during a closing audit will be described with reference to FIG. 13. In FIG. 13, a description starts from step S16 on the assumption that steps are executed continuously from the flow of data processing of the monthly closing audit shown in FIG. 12.

Step S16 is a title closing total balance calculation step executed by the title total balance calculation unit 36. At this step, the title monthly total balance data 41 stored in the title total balance database 40 is read out, and a calculation is then performed, and title closing total balance data 42 is generated and is readably stored in the title total balance database 40.

Next, step S17 will be described. Step S17 is a title total balance read-in step executed by the tax verification unit 37. At this step, the tax verification unit 37 reads out the title monthly total balance data 41 stored in the title total balance database 40. As described above, although it is conceivable that the title monthly total balance data 41 is absent in the title total balance database 40 if the title monthly total balance data 41 has already been calculated at step S3, the title monthly total balance data 41 will be read out from the related-party standardization file 18 of the standardization file database 12 if so.

Step S18 is a title closing total balance read-in step executed by the tax verification unit 37. At this step, the tax verification unit 37 reads out the title closing total balance data 42 stored in the title total balance database 40.

Step S19 is an accounting journalization information read-in step executed by the tax verification unit 37 in the same way. At this step, the tax verification unit 37 reads out the monthly journalization information data 47 from the accounting journalization information database 46. As described above, although it is conceivable that the accounting journalization information database 46 is absent if the monthly journalization information data 47 has already been totalized at step S3, the accounting journalization information database 46 will be read out from the related-party standardization file 18 of the standardization file database 12 if so. The order from step S17 to step 19 is negligible, and any one of the three steps may be first executed, or the three steps may be executed simultaneously.

Likewise, at step S20, the tax verification unit 37 executes a closing audit processing step. At this step, the tax verification unit 37 reads out the verification item data 54 from the closing audit database 53, and thereafter the title monthly total balance data 41, the title closing total balance data 42, and the monthly journalization information data 47 are collated with respect to the verification item data 54, and at least correlated verification items are extracted and are readably stored in the closing audit database 53 as verification result data 55.

The operation and the effect brought about by the flow of data processing performed during the closing audit have already been described with reference to FIG. 11 and the other figures, and therefore, a description of these operation and effect is omitted.

The process concerning the closing audit of steps S16 to S20 can also be executed independently of the process concerning the monthly audit (traveling audit) of steps S8 to S11 and steps S12 to S15, and therefore, if data for the closing of accounts has been completely prepared, the process concerning the closing audit is not necessarily required to be executed after executing the process concerning the monthly audit.

### INDUSTRIAL APPLICABILITY

One or more embodiments of the present invention are applicable to the operational efficiency improvement and the accuracy improvement of offices where tax/account service is performed while having many clients (related parties), and is widely applicable to the operational efficiency improvement and the operational accuracy improvement of account/tax processing in general corporations that are enlarging or diversifying. Additionally, the present invention can be more widely included in, for example, an ERP (Enterprise Resource Planning) package.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

### DESCRIPTION OF REFERENCE SYMBOLS

1 . . . Accounting journalization file data standardization system
1a . . . Audit system
2 . . . Input unit
3 . . . File read-in setting unit
4 . . . Arithmetic unit
5 . . . File data placement standardization unit
6 . . . Title matching processing unit
7 . . . Related-party title search unit
8 . . . Standard title search unit
9 . . . Extraction title linkage processing unit
10 . . . Output unit
11 . . . File database
12 . . . Standardization file database
13 . . . File data placement information database
14 . . . Standard title information database
15 . . . Related-party title information database
16 . . . Matched title information database
17 . . . Related-party accounting journalization file
18 . . . Related-party standardization file
20 . . . Standard data placement structure
21 . . . Standard title data
22 . . . Linkage title data
23 . . . Matched title data
30 . . . Traveling audit processing unit
31 . . . Title total balance calculation unit
32 . . . Title balance checkup execution unit
33 . . . Accounting journalization totalization unit
34 . . . Title checkup execution unit
35 . . . Closing audit processing unit
36 . . . Title total balance calculation unit
37 . . . Tax verification unit
40 . . . Title total balance database
41 . . . Title monthly total balance data
42 . . . Title closing total balance data
43 . . . Balance checkup database
44 . . . Balance checkup item data
45 . . . Balance checkup result data
46 . . . Accounting journalization information database
47 . . . Monthly journalization information data
50 . . . Title checkup database
51 . . . Title checkup item data
52 . . . Title checkup result data
53 . . . Closing audit database
54 . . . Verification item data
55 . . . Verification result data
a to n . . . Data placement structure

What is claimed is:

1. An accounting journalization file data standardization system that performs account processing common to each related party by use of accounting journalization files from a plurality of related parties, the accounting journalization file data standardization system comprising:
a file data placement information database that stores a data placement structure relative to data items and data positions of accounting journalization files created by a plurality of specifications differing from each other;
a file data placement standardization unit that reads in the related-party accounting journalization file, thereafter reads out a related-party data placement structure (a) corresponding to a specification that has created the related-party accounting journalization file from the file data placement information database, thereafter searches for enumerating data included in the related-party accounting journalization file in accordance with the related-party data placement structure (a), and generates and outputs a related-party standardization file in which the data item and the data position of the related-party data placement structure (a) are combined with each piece of data included in the enumerating data;
giving a standard title ID regarding a predetermined desired debit title name and/or a credit title name as a standard title name;
a related-party title information database that stores a linkage title in which the standard title ID of the standard title name desirably correlated is linked to the debit title name and/or the credit title name of the data items of the related-party standardization file;
a matched title information database that collects linkage titles in each of which the standard title ID of the standard title name desirably correlated is linked to the debit title name and/or the credit title name of the data items of the related-party standardization files and that stores these linkage titles as matched titles; and
a title matching processing unit that links the standard title ID of the standard title name desirably correlated is linked to the debit title name and/or the credit title name of the data items of the related-party standardization files,
the title matching processing unit including:
a related-party title search unit that extracts the debit title name and/or the credit title name of the data items from the related-party standardization files and searches for a linkage title to which the standard title ID stored in the related-party title information database is linked while using these title names as keys; and
a standard title search unit that searches for a matched title in which the standard title ID stored in the matched title information database is linked to the debit title name and/or the credit title name for which the related-party title search unit was not able to search while using these title names as keys and that links the standard title ID of the matched title to the debit title name and/or the credit title name for which the related-party title search unit was not able to search.

2. The accounting journalization file data standardization system according to claim 1, wherein the file data placement standardization unit searches for enumerating data included in the related-party accounting journalization file in accordance with the related-party data placement structure (a), and thereafter generates and outputs a related-party standardization file in which a data item and a data position of a standard data placement structure desirably predetermining the data item and the data position of the accounting journalization file and each piece of data included in the enumerating data are combined together instead of the data item and the data position of the related-party data placement structure (a).

3. The accounting journalization file data standardization system according to claim 1, further comprising a standard title information database that stores the standard title name and a standard title ID corresponding to the standard title name,
wherein the title matching processing unit includes an extraction title linkage processing unit, the extraction title linkage processing unit linking the standard title ID of the standard title name desirably correlated while searching for the standard title information database with respect to the debit title name and/or the credit title name that has not been retrieved by the standard title search unit or linking a standard title ID of a new standard title name desirably correlated with respect thereto, the extraction title linkage processing unit thereafter storing resultant data in the matched title information database as a matched title and/or in the related-party title information database as a linkage title.

4. An accounting journalization file data standardization program that is a program executed to standardize accounting journalization file data in order to perform account processing common to each related party by use of accounting journalization files from a plurality of related parties by means of a computer, the program including:
a file data placement information storage step of storing a data placement structure relative to data items and data positions of accounting journalization files created by a plurality of specifications differing from each other in a file data placement information database;
an accounting journalization file read-in step of reading in a related-party accounting journalization file;
a data placement structure search step of reading out a related-party data placement structure (a) corresponding to the specification that has created the related-party accounting journalization file from the file data placement information database and searching for enumerating data included in the related-party accounting journalization file in accordance with the related-party data placement structure (a);
a file data placement standardization step of generating and outputting a related-party standardization file in which the data item and the data position of the related-party data placement structure (a) and each piece of data included in the enumerating data are combined together;
giving a standard title ID regarding a predetermined desired debit title name and/or a credit title name as a standard title name;
a related-party title information database that stores a linkage title in which the standard title ID of the standard title name desirably correlated is linked to the debit title name and/or the credit title name of the data items of the related-party standardization file;
a matched title information database that collects linkage titles in each of which the standard title ID of the standard title name desirably correlated is linked to the debit title name and/or the credit title name of the data items of plurality of the related-party standardization files and that stores these linkage titles as matched titles; and
a title matching processing step of linking the standard title ID of the standard title name desirably correlated is linked to the debit title name and/or the credit title name of the data items of the related-party standardization files,
the title matching processing step including:
a debit/credit title extraction step of extracting a debit title name and/or a credit title name of the data items from the related-party standardization file;
a related-party title search step of searching for a linkage title to which the standard title ID stored in the related-party title information database has been linked while using the debit title name and/or the credit title name extracted at the debit/credit title extraction step as a key; and a standard title search step of searching for a matched title in which the standard title ID stored in the matched title information database is linked to debit title names and/or credit title names that have not been retrieved at the related-party title search step while using these title names as keys and of linking the standard title ID of the matched title to the debit title names and/or the credit title names that have not been retrieved at the related-party title search step,
the accounting journalization file data standardization program allowing the computer to execute these steps.

5. The accounting journalization file data standardization program according to claim 4, wherein the file data placement standardization step is a step of generating and outputting a related-party standardization file in which a data item and a data position of a standard data placement structure desirably predetermining the data item and the data position of an accounting journalization file and each piece of data included in the enumerating data are combined together instead of the data item and the data position of the related-party data placement structure (a).

6. The accounting journalization file data standardization program according to claim 4, further comprising a standard title information database that stores the standard title name and a standard title ID corresponding to the standard title name,
wherein the title matching processing step includes an extraction title linkage processing step, the extraction title linkage processing step linking the standard title ID of the standard title name desirably correlated while searching for the standard title information database (14) with respect to the debit title name and/or the credit title name that has not been retrieved at the standard title search step or linking a standard title ID of a new standard title name desirably correlated with respect thereto, the extraction title linkage processing step thereafter storing resultant data in the matched title information database as a matched title and/or in the related-party title information database as a linkage title.

7. An audit system comprising the accounting journalization file data standardization system according to claim 1, and including:
a title total balance calculation unit that reads out a related-party standardization file from the accounting journalization file data standardization system and calculates a title total balance for a desirably determined period for each debit title and each credit title included in the related-party standardization file;
a balance checkup database that stores balance checkup items desirably determined to make an audit checkup with respect to a title total balance of each debit title and of each credit title; and
a title balance checkup execution unit that reads out the title total balance from the title total balance calculation unit, thereafter reads out the balance checkup item from the balance checkup database, thereafter collates the title total balance of each debit title and of each credit title with respect to the balance checkup item, thereafter extracts at least a correlated balance checkup item and a debit title name or a credit title name, and readably stores an extracted item and an extracted name in the balance checkup database as balance checkup results.

8. An audit system comprising the accounting journalization file data standardization system according to claim 1, and including:
an accounting journalization totalization unit that reads out a related-party standardization file from the accounting journalization file data standardization system, thereafter totalizes related-party accounting journalization included in the related-party standardization file for a desirably determined period, and generates accounting journalization information;
a title checkup database that stores title checkup items desirably determined to make an audit checkup with respect to the accounting journalization information; and
a title checkup execution unit that reads out the accounting journalization information from the accounting journalization totalization unit, thereafter reads out the title checkup item from the title checkup database, thereafter collates the accounting journalization information with respect to the title checkup item, thereafter extracts at least a correlated title checkup item and a piece of accounting journalization information, and readably stores an extracted item and an extracted piece of information in the title checkup database as title checkup results.

9. An audit system comprising the accounting journalization file data standardization system according to claim 1, and including:
a title total balance calculation unit that reads out a related-party standardization file from the accounting journalization file data standardization system and calculates a title total balance for a desirably determined period and a title closing total balance in each year of closing of accounts for each debit title and each credit title included in the related-party standardization file;
an accounting journalization totalization unit that totalizes related-party accounting journalization included in the related-party standardization file for a desirably determined period and generates accounting journalization information; and
a closing audit processing unit that reads out the title total balance and the title closing total balance from the title total balance calculation unit, thereafter reads out the accounting journalization information from the accounting journalization totalization unit, thereafter collates the title total balance and/or the title closing total balance and/or the accounting journalization information with respect to verification items desirably determined to make an audit checkup, and extracts at least a correlated verification item.

10. An audit program comprising the accounting journalization file data standardization program according to claim 4, the audit program being executed to perform audit processing common to each of a plurality of related parties by means of a computer by use of a related-party standardization file obtained by execution of the accounting journalization file data standardization program, the audit program allowing the computer to execute:
a title total balance calculation step of reading out the related-party standardization file and calculating a title total balance for a desirably determined period for each debit title and each credit title included in the related-party standardization file, and
a title balance checkup execution step of reading out the balance checkup item from a balance checkup database that readably stores balance checkup items desirably determined to make an audit checkup with respect to a title total balance of each debit title and of each credit title, thereafter collating the title total balance of each debit title and of each credit title with respect to the balance checkup item, thereafter extracting at least a correlated balance checkup item and a debit title name or a credit title name, and readably storing an extracted item and an extracted name in the balance checkup database as balance checkup results.

11. An audit program comprising the accounting journalization file data standardization program according to claim 4, the audit program being executed to perform audit processing common to each of a plurality of related parties by means of a computer by use of a related-party standardization file obtained by execution of the accounting journalization file data standardization program, the audit program allowing the computer to execute:
an accounting journalization totalization step of totalizing related-party accounting journalization included in the related-party standardization file for a desirably determined period and generating accounting journalization information, and
a title checkup execution step of reading out the title checkup item from a title checkup database that readably stores title checkup items desirably determined to make an audit checkup with respect to the accounting journalization information, thereafter collating the accounting journalization information with respect to the title checkup item, thereafter extracting at least a correlated title checkup item and a piece of accounting journalization information, and readably storing an extracted item and an extracted piece of information in the title checkup database as title checkup results.

12. An audit program comprising the accounting journalization file data standardization program according to claim 4, the audit program being executed to perform audit processing common to each of a plurality of related parties by means of a computer by use of a related-party standardization file obtained by execution of the accounting journalization file data standardization program, the audit program allowing the computer to execute:
a title total balance calculation step of reading out the related-party standardization file and calculating a title total balance for a desirably determined period and a title closing total balance in each year of closing of accounts for each debit title and each credit title included in the related-party standardization file;
an accounting journalization totalization step of totalizing related-party accounting journalization included in the related-party standardization file for a desirably determined period and generating accounting journalization information; and
a closing audit processing step of collating the title total balance and/or the title closing total balance and/or the accounting journalization information with respect to verification items desirably determined to make an audit checkup and extracting at least a correlated verification item.
